(19) United States
(12) Patent Application Publication
(10) Pub. No.: US 2023/0306980 A1
(43) Pub. Date: Sep. 28, 2023

(54) Method and System for Audio Signal Enhancement with Reduced Latency

(71) Applicant: Mitsubishi Electric Research Laboratories, Inc., Cambridge, MA (US)

(72) Inventors: Zhong Qiu Wang, Cambridge, MA (US); Gordon Wichern, Cambridge, MA (US); Jonathan Le Roux, Cambridge, MA (US)

(21) Appl. No.: 18/045,380

(22) Filed: Oct. 10, 2022

Related U.S. Application Data
(60) Provisional application No. 63/269,468, filed on Mar. 17, 2022.

(51) Int. Cl. G10L 21/0232; H04S 3/00; H04R 1/40; H04R 3/00; G10L 25/30

(52) U.S. Cl. CPC G10L 21/0232; G10L 25/30; H04R 1/406; H04R 3/005; H04S 3/008; G10L 2021/02082; H04S 2400/01

(57) ABSTRACT

A system and method for low-latency audio signal enhancement is provided. An input mixture of audio signals is partitioned into a sequence of overlapping frames by using a first sliding window method. The first sliding window method comprises a first window function having a first width associated with a window of the corresponding frame and a shift length associated with shifting of the window of the first sliding window method. Each frame is then processed using a first DNN, a frequency domain causal linear filter and a second DNN, to generate final enhanced overlapping frames for each of the processed frames. The final enhanced overlapping frames are then combined using a second sliding window method associated with a second window function having a second width less than the first width and the same shift length as the first sliding window method.

### TECHNICAL FIELD

The present disclosure generally relates to audio signal processing and more particularly to method and system for low latency enhancement of audio signals.

### BACKGROUND

Audio signal processing is a technological concept that has diverse applications, with each application having its unique set of requirements. The technique for audio signal processing that are successful in one application area, may not operate successfully in a different application area. For example, in an enclosed environment, it may be important to mitigate effects of reverberation of an audio signal using audio signal processing, while in an application like hearing aids, reducing latency in processing of the audio signal is more important than reverberation mitigation. This is because in the enclosed room, the audio signal, such as the speech signal propagates in air and may be reflected by a wall, a floor, a ceiling, and any other objects in the room before being captured by a microphone. The reverberation is a multi-path propagation of a speech signal from a source or a speaker to a receiving end, such as a microphone. Such speech reverberation occurs when sound reflects off surfaces in an environment. Some of the sound may be absorbed by the surfaces due to which multiple attenuation of the speech signal occurs. The reflection and the absorption of the sound by the surfaces may generate multiple attenuated copies and delayed copies of the speech signal. The multiple attenuated copies and the delayed copies degrade quality of the speech, which may hinder performance of an automatic speech recognition (ASR) system or any speech/audio processing system. For instance, the ASR may generate inaccurate output due to an audio input with the degraded quality of the speech.

On the other hand, in many application scenarios such as teleconferencing and hearing aids, low-latency speech enhancement and speaker separation is more important. In modem day learning based audio signal processing systems, this is managed by using causal neural network blocks, such as unidirectional Long short-term memories (LSTMs), causal convolutions, causal attention layers, and causal normalization layers. Although these systems are believed to be causal and real-time with a causal Deep Neural Network (DNN) at the core, these systems are, to be more precise, frame-online, and the amount of look-ahead depends on the frame length used in audio signal processing. One major approach that can potentially achieve sample-level causal processing is by using Wave Net-like model, which is essentially a deep generative model of raw audio waveforms.

However, the effectiveness of these known systems in dealing with noise and reverberation in a sample-causal setup is not clear. In addition, at run time such models need to perform feedforwarding at each sample, resulting in extremely large and possibly unnecessary amounts of computation.

Some audio signal processing approaches like Short-time Fourier Transform (STFT) and time-domain approaches typically split audio signals into overlapped frames before processing. In these approaches, the audio signal is multiplied by a window function, having associated with it a processing window of a predefined length or width, to transform it into multiple overlapped frames. The processing latency in these approaches is equivalent to window length due to the use of overlap-add in signal resynthesis, plus the running time of processing one frame. However, these approaches suffer from the drawback that the processing latency is high for real-time applications like hearing aids and teleconferencing applications. As an example, for a typical STFT based system with a 32 milliseconds (ms) window and an 8 ms hop size, a frame online DNN based system satisfies the latency requirement if the processing of each frame can finish within 8 ms on the specified processor, since a new frame will come in for processing every 8 ms. The overall latency in such an example is 40 ms, which is not ideal. In fact, for applications like hearing aids design, the required algorithmic latency is 5 ms at maximum, which is much lower than this exemplar latency. Such a low-latency constraint requires new designs and significant modifications of existing audio processing algorithms.

To overcome the above mentioned problem in case of hearing-aids, some known solutions use a 4 ms window for the window function and a 1 ms hop size in some STFT based hearing aids studies. However, using a 4 ms window leads to a much lower frequency resolution than a 32 ms window. In deep learning based T-F masking, it is well-known that, given the same hop size, a longer window, hence higher frequency resolution, usually leads to better oracle separation than a shorter window. In addition, for multi-microphone processing, using a short window may not be particularly good at reliably capturing inter-channel phase patterns, because the windowed signals might be too short to exhibit salient signal delays. But it has been observed in these prior solutions that short window length, and hence low resolution does not lead to accurate STFT based audio signal processing.

However, in some time-domain signal processing approaches, such as Conv-TasNet, which uses a linear encoder to generate a representation of the speech waveform optimized for separating individual speakers, noticeably short window and hop sizes can be used for very low-latency separation. Further, Conv-TasNet is able to leverage DNN based end-to-end optimization to learn a set of basis for a small window of samples respectively for its encoder and decoder to replace the conventional STFT and inverse STFT (iSTFT) operations. Separation is then performed in the encoded space and the decoder is used for overlap-adding based signal resynthesis. Although achieving good separation performance in monaural anechoic speaker separation tasks, they perform much less impressive in reverberant conditions and in multi-microphone scenarios than frequency-domain approaches. In addition, the learned basis by TasNet is not narrowband. It is not straightforward how to directly combine TasNet with conventional STFT-domain separation algorithms, such as beamforming and weighted prediction error (WPE), which rely on the narrow-band assumption and can produce reliable separation and dereverberation through their per-frequency processing. One way of combining them is by iterating TasNet, which uses a noticeably short window, with STFT-domain beamforming, which uses a regular, longer window. To use TasNet outputs to compute signal statistics for STFT-domain beamforming, one has to first resynthesize time-domain signals before extracting STFT spectra for beamforming.

Similarly, to apply TasNet on beamforming results for post-filtering, one has to apply iSTFT to get time-domain signals before feeding them to TasNet. This iterative procedure would however gradually build up the algorithmic latency because the overlap-add algorithms are used multiple times in TasNet and iSTFT. Other time-domain approaches which use regularly large window size like 32 ms suffer from the same problems as STFT-based systems.

Accordingly, there is a need to overcome the above-mentioned problems. More specifically, there is need to develop a method and system for low-latency processing of audio signals, while overcoming reverberant conditions and non-stationary noises in an environment.

### SUMMARY

It is an object of some embodiments to develop a method and a system for efficient, accurate and low latency based processing of audio signals, or the like.

Some embodiments are based on the understanding that STFT domain methods for audio signal processing, such as a task of speaker separation typically use a large window length such as 32 ms and 75% overlap between consecutive frames. This however incurs at least 32 ms latency, because the overlap-add algorithm used in inverse STFT (iSTFT) is also performed based on a 32 ms window size. However, this inherent latency needs to be reduced for applications like hearing aids design which need latency as low as 5 ms. To reduce this inherent latency, some embodiments of the present disclosure provide a novel dual window size approach for STFT-domain low-latency audio signal processing, such as for use in hearing aids design or the task of speaker separation.

Some embodiments are based on the realization that a regular window size is used for STFT extraction, but a much smaller window size is used for the overlap-add in iSTFT. This approach can leverage a reasonably high frequency resolution for separation while at the same time keeping the latency low. Based on this novel STFT representation, single- or multi-microphone complex spectral mapping of audio signals is applied for frame-online separation, where one or multiple DNNs are trained to predict the real and imaginary (RI) components of target speech from the RI components of the received audio signals, such as an input acoustic mixture of signals. Since the STFT method is naturally narrowband, the predicted RI components by a first DNN are used to conduct per-frequency frame-online frequency domain linear causal filtering, such as beamforming and convolutive prediction based dereverberation. The beamforming and dereverberation results are then used as extra features for a second DNN for post-filtering. The inclusion of frequency-domain linear causal filtering, in this case beamforming and dereverberation, in between the two DNNs dramatically improves the performance and can be easily integrated with complex spectral mapping, while this inclusion is not possible for time-domain approaches without incurring processing delays. Evaluations results on SMS-WSJ, a benchmark dataset for speech separation, demonstrate the effectiveness of the proposed approach.

Some embodiments disclosed herein provide a reduced algorithmic latency of audio processing, to as low as 4 and 2 ms, while still achieving a strong performance.

Some embodiments are based on an understanding that the audio signals may correspond to clean speech which exhibits spectral-temporal patterns. Such spectral-temporal patterns are unique patterns that are exhibited in time-frequency domain and may provide an informative cue for reducing reverberation. While some of the patterns stem from the structure of the speech signal itself, some patterns may also correspond to a linear filter structure of reverberation (i.e., reflection of soundwaves) that is characteristic of the physical space in which the recording is made, including all objects, structures, or entities present in that space, and the positions of the source speech signal and a receiver such as a microphone recording the signal. The signal resulting at a microphone location from the source signal and its reflections on walls and surfaces of objects or people in the space can be described using this linear filter structure, expressing the effect of reverberation on an input signal as a linear convolution of the input signal and a room impulse response (RIR). The input signal is an original source signal also known as the dry source signal. The room impulse response is a representation of the effect of the space and everything inside it on the input signal. An estimate of the RIR between a source location and a receiver location can be recorded in a physical space, such as a room, for example by playing an impulsive sound which is a short-duration time-domain signal (e.g., a blank pistol or a balloon exploding) in the room at the source location and recording the subsequent signal at the receiver location. The impulse excites the room and creates a reverberated impulse signal that can be used to estimate the RIR.

The reverberation of a dry source sound signal that would be played at the same source location and recorded at the same receiver location can then be modeled by convolving the dry source signal and the estimated RIR.

Further, such linear filter may be leveraged as regularization for improving the dereverberation process. For instance, the linear filter as the regularization prevents overfitting of a model for the dereverberation process to a training data. Some embodiments are based on the realization that the linear filter structure may be exploited for a combination of linear prediction and deep learning for single as well as multi-channel reverberant speaker separation and dereverberation tasks. To that end, the deep learning techniques supported with a convolutive prediction may be used for the dereverberation in an environment with noise signals, reverberations of audio signals, or the like. The convolutive prediction is a linear prediction method for speech dereverberation in reverberant conditions, which relies on source estimates obtained by DNNs and exploits a linear filter structure between the source estimate and the reverberant version of the source signal within the observed input signal.

To obtain source estimates, the DNNs are trained in the time-frequency or time domain to predict target speech from reverberant speech. The target speech corresponds to a target direct-path signal between a source and a receiver, such as a microphone. This approach may leverage prior knowledge of speech patterns.

Prior works also attempt to leverage some form of linear filter structure in order to perform dereverberation. For instance, weighted prediction error (WPE) may be used for the dereverberation of speech signals. The WPE method computes an inverse linear filter based on variance-normalized delayed linear prediction. The computed linear filter is applied to past observations of the reverberant and potentially noisy mixture input signal to estimate late reverberation of a target source signal within the mixture input signal from the past observations of reverberation for the dereverberation. The estimated late reverberation is subtracted from a mixture of acoustic signals that is received from different sources, to estimate a target speech signal in the mixture of acoustic signals. In some embodiments, the filter may also be estimated with a time-varying power spectral density (PSD) of the target speech signal. The PSD is a distribution of power of a signal over frequency ranges of the signal. Such linear filter may be iteratively estimated using WPE in an unsupervised manner. However, WPE’s iterative procedure for the filter estimation may lead to suboptimal results and be computationally expensive.

In order to overcome the aforementioned deficiencies of the WPE, the iterative procedure for the filter estimation may be replaced as in the DNN based WPE (DNN-WPE) approach. The DNN-WPE uses DNN-estimated magnitudes as PSD of the target speech signal for the filter estimation. However, DNN-WPE may not reduce early reflections, because it requires a strict non-zero frame delay to avoid trivial solutions and may not have a mechanism to utilize DNN estimated phase for the filter estimation. DNN-WPE may also lack robustness to interference due to noise signals. For instance, DNN-WPE may estimate a filter that relates past noisy observations to a current noisy observation, thereby limiting the filter estimation accuracy. In addition, DNN-WPE may directly use linear prediction results as its outputs, resulting in partial or minimum reduction of reverberation.

To that end, it is also an object of some embodiments to estimate an underlying filter for approximating or modeling the RIR. In some example embodiments, the RIR may be estimated based on a linear regression problem that is solved per frequency in the time-frequency domain. The filter estimate modeling the RIR may be used to identify delayed and decayed copies of the input signal for the dereverberation of speech signals.

In some cases, the mixture of acoustic signals may be received from a single channel, such as a single microphone, or from multiple channels, such as an array of microphones. Each different channel measures a different version of the mixture of acoustic signals. In that case, more than one DNNs may be trained to estimate a target direct-path signal of a received signal at a reference channel or at each channel. The training of each of the DNNs may be based on the complex spectral mapping at one or more channel, wherein the DNNs are trained to output an estimate in a time-frequency domain of the target direct-path signal at the one or more channels such that a distance between the estimate and a reference in the time-frequency domain of the target direct-path signal at the one or more channels is minimized.

In case of the array of microphones, a beamforming output may be obtained. The beamforming output may be obtained based on statistics computed from one or combination of the first estimates of the target direct-path signals at each microphone of the array of microphones and the mixture with reduced reverberation of the target direct-path signal. The beamforming output may be inputted to the second DNN to produce the second estimate of the target direct-path signal for each of the multiple speakers. Additionally or alternatively, the beamforming output and dereverberation results may be used as additional features for the second DNN to perform better separation and dereverberation tasks, which may be considered tasks related to audio signal enhancement processing or speech enhancement processing.

To that end, some embodiments provide a system and a method for audio signal enhancement processing which use different window sizes for analysis at input (STFT) and synthesis at output (iSTFT). For example, some embodiments provide for a 32 ms window and 1 ms hop size for STFT, while a 4 ms window and 1 ms hop size for the overlap-add in iSTFT. The 32 ms window for STFT looks 4 ms ahead and 28 ms in the past.

To that end, the audio signal is processed in a frame-online configuration using the two DNNs with a linear filtering module in between, and asymmetric windowing methods having different window sizes at input (analysis) and output (or synthesis) sides. In an example, the audio signal is synthesized by performing inverse discrete Fourier transform (iDFT), and thereafter the first 28 ms of waveform of the audio signal is discarded, and then the synthesis window is applied to perform overlap-add based on the last 4 ms of waveforms at each frame. This dual window size approach, which uses different window sizes for STFT and overlap-add, has several advantages. First, using a longer window for STFT leads to higher frequency resolution, thus providing more estimated filters (or mask values) per frame to obtain more fine-grained audio signal separation. In addition, higher frequency resolution can better leverage the speech sparsity property in the T-F domain for separation. Second, using a longer window for STFT can capture more reverberation at each frame, potentially leading to better dereverberation. Third, using a larger window for STFT could lead to better spatial processing, as the inter-channel phase patterns could be more stable and salient for longer signals. Fourth, STFT basis are narrowband in nature, thus enabling use of DNN outputs, i.e. the estimated target RI components, to compute signal statistics for conventional frequency-domain beamforming and dereverberation, the results of which can be used as extra features for another DNN to better predict target speech.

Accordingly, some embodiments provide a signal enhancement method executed by a computer for processing of an input mixture of audio signals. The signal enhancement method comprises receiving, via an input interface, the input mixture of audio signals, which could be a single-channel audio signal or a multi-channel audio signal. The input mixture of audio signals is then partitioned into a sequence of input overlapping frames using a first sliding window method having a first window function having a first width associated with a window of the corresponding frame and a shift length associated with shifting of the window of the first sliding window method. The first width corresponds to a window length and the shift length corresponds to a hop size of a sliding window method in some embodiments. The shift length is equal to or less than twenty percent of the first width associated with the window. Each frame of the partitioned overlapping frames is then processed using a first deep neural network (DNN) to generate enhanced overlapping frames comprising a corresponding enhanced frame for each processed frame in the overlapping frames. Further, a frequency domain filtering output is generated for each frame of the enhanced overlapping frames. The frequency domain filtering output is then processed using a second DNN to generate a corresponding final enhanced frame for each frame of the enhanced overlapping frames. Then, the final enhanced overlapping frames are combined using a second sliding method associated with a second window function having a second width less than the first width. To that end, the higher first width provides a high frequency resolution at the input side of the audio signal processing, while a lesser or shorter second width provides a low latency at an output side.

To that end, some embodiments provide that the second width is a multiple of the first width. Additionally, the second sliding window method is also associated with a sliding window hop size or shift length, which may be same as the shift length of the first sliding window method.

In some embodiments, the second width is at least equal to double of the shift length.

In some embodiments, the first window function and the second window function are each an asymmetric window function.

Some embodiments provide that the first width is at least equal to 32 milliseconds (ms), the second width is at least equal to 4 ms, and the shift width is at least equal to 2 ms.

In some embodiments, the frequency domain filtering output for each frame of the enhanced overlapping frames is a causal linear filtering output generated by a causal linear filter. The causal linear filter is a multi-channel weiner filter (MCWF) in some embodiments.

In some embodiments, the generating of the frequency domain filtering output for each frame of the enhanced overlapping frames comprises generating a beamforming output as the frequency domain filtering output for each frame of the enhanced overlapping frames. Further, the beamforming output is submitted to the second DNN to generate the corresponding final enhanced frame for each frame of the enhanced overlapping frames.

To that end, some embodiments provide producing a first estimate of an intermediate representation for each frame, using the first DNN. Further, estimation of a filter modeling a room impulse response (RIR) for the first estimate of the intermediate representation for each frame is done. This filter is used to obtaining a mixture with reduced reverberation of the intermediate representation for each frame by removing the result of applying the filter to the intermediate representation for each frame from the received mixture of audio signals. The mixture with reduced reverberation is then submitted to the second DNN to produce a second estimate of the intermediate representation for each frame. The second estimate of the intermediate representation for each frame is then outputted via an output interface.

In some embodiments, the filter comprises a linear filter based on a convolutive prediction technique.

In some embodiments, the received multi-channel audio signal includes speech signals from multiple speakers, and the first DNN produces multiple outputs, each output of the multiple outputs including the first estimate of the intermediate representation for each frame for a speaker from the multiple speakers. To that end, the multi-channel signal corresponding to the input mixture of audio signals is received from an array of microphones connected to the input interface.

In some embodiments, receiving of the multi-channel audio signal from the array of microphones, further comprises: obtaining a beamforming output based on statistics computed from one or combination of the first estimate of the intermediate representation for each frame at each microphone of the array of microphones and the mixture with reduced reverberation of the intermediate representation for each frame; and submitting the beamforming output to the second DNN to produce a second estimate of the intermediate representation for each frame.

In some embodiments the first DNN is pretrained (offline) to obtain the first estimate of the intermediate representation for each frame from an observed mixture of acoustic signals. The pretraining of the first DNN is performed using a training dataset of mixtures of acoustic signals and corresponding reference target direct-path signals in the training dataset, by minimizing a loss function. The loss function comprises one or a combination of: a distance function defined based on real and imaginary (RI) components of the first estimate of the intermediate representation for each frame in a first time-frequency domain and RI components of the corresponding reference target direct-path signal in the first time-frequency domain, a distance function defined based on a magnitude obtained from the RI components of the first estimate of the intermediate representation for each frame in the first time-frequency domain and corresponding magnitude of the reference target direct-path signal in the first time-frequency domain, a distance function defined based on a reconstructed waveform obtained from the RI components of the first estimate of the intermediate representation for each frame in the first time-frequency domain by reconstruction in a time domain and a waveform of the reference target direct-path signal, a distance function defined based on the RI components of the first estimate in a second time-frequency domain obtained by transforming the reconstructed waveform further in the time-frequency domain and the RI components of the reference target direct-path signal in the second time-frequency domain, and a distance function defined based on the magnitude obtained from the RI components of the first estimate of the intermediate representation for each frame in the second time-frequency domain obtained by transforming the reconstructed waveform further in the time-frequency domain and the corresponding magnitude of the reference target direct-path signal in the second time-frequency domain.

Various embodiments provide a signal enhancement system for processing of an input mixture of audio signals, the signal enhancement system comprising an input interface configured to receive the input mixture of audio signals, wherein the input mixture of audio signals is at least one of a multi-channel audio signal or a single-channel audio signal. The signal enhancement system further comprises a memory storing computer-executable instructions, and a processor configured to execute the computer-executable instructions. The computer-executable instructions configured to: partition the received input mixture of audio signals into a sequence of input overlapping frames using a first sliding window method, the first sliding window method comprising a first window function having a first width associated with a window of the corresponding frame and a shift length associated with shifting of the window of the first sliding window protocol, such that the shift length is equal to or less than twenty percent of the first width associated with the window. The computer-executable instructions further configured to process the partitioned sequence of the overlapping frames using a first deep neural network (DNN) to generate enhanced overlapping frames, the enhanced overlapping frames comprising a corresponding enhanced frame for each of the processed frame in the input overlapping frames. The computer-executable instructions further configured to generate a frequency domain filtering output for each frame of the enhanced overlapping frames; process, using a second DNN, the frequency domain filtering output for each frame of the enhanced overlapping frames, to generate a corresponding final enhanced frame for each frame of the enhanced overlapping frame; and combine the final enhanced overlapping frames using a second sliding window method associated with a second window function having a second width less than the first width and the same shift length as the first sliding window method.

Further features and advantages will become more readily apparent from the following detailed description when taken in conjunction with the accompanying drawings.

### BRIEF DESCRIPTION OF THE DRAWINGS

The present disclosure is further described in the detailed description which follows, in reference to the noted plurality of drawings by way of non-limiting examples of exemplary embodiments of the present disclosure, in which like reference numerals represent similar parts throughout the several views of the drawings. The drawings shown are not necessarily to scale, with emphasis instead generally being placed upon illustrating the principles of the presently disclosed embodiments.

FIG. 1A illustrates a block diagram of a signal enhancement system, according to some embodiments of the present disclosure.

FIG. 1B illustrates a detailed block diagram of functions performed by the signal enhancement system of FIG. 1A for audio signal processing illustrated in FIG. 1, according to an embodiment of the present disclosure.

FIG. 1C illustrates an exemplar window function, according to an embodiment of the present disclosure.

FIG. 1D illustrates an example of an asymmetric window function, according to an embodiment of the present disclosure.

FIG. 2A illustrates a schematic block diagram of steps performed during partitioning of an input audio signal using a first sliding window method, according to embodiments of the present disclosure.

FIG. 2B illustrates a schematic block diagram of steps performed during combining of an enhanced audio signal using a second sliding window method, according to embodiments of the present disclosure.

FIG. 2C illustrates a schematic block diagram of steps performed during enhancement of the partitioned audio signal using deep learning based architecture, according to embodiments of the present disclosure.

FIG. 3A illustrates a schematic block diagram of an audio signal enhancement process, according to embodiments of the present disclosure.

FIG. 3B illustrates another schematic block diagram of another audio signal enhancement process, according to embodiments of the present disclosure.

FIG. 3C illustrates the signal enhancement system having two DNNs, according to an embodiment of the present disclosure.

FIG. 3D shows a schematic diagram of an architectural representation for enhancement of audio signals, according to embodiments of the present disclosure.

FIG. 4 illustrates a schematic diagram depicting a corresponding network architecture for each of the two DNNs used in the signal enhancement system, according to embodiments of the present disclosure.

FIG. 5 is a block diagram of an audio processing system, according to embodiments of the present disclosure.

FIG. 6 illustrates a use case for enhancement of speech signals in a teleconferencing set-up, according to some example embodiments of the present disclosure.

FIG. 7 illustrates a use case for enhancement of speech signals in a hearing-aid, according to some example embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure. Contemplated are various changes that may be made in the function and arrangement of elements without departing from the spirit and scope of the subject matter disclosed as set forth in the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

While most of the descriptions are made using speech as a target sound source, the same methods can be applied to other types of audio signals.

Audio signals are increasingly being processed using deep learning methodologies, specifically based on use of DNNs for audio signal enhancement tasks such as reverberation modeling, speaker separation, accurate sound source identification and the like. Some application scenarios of audio signal enhancement, such as teleconferencing and hearing aids require low-latency speech enhancement. The present disclosure provides methods and systems for performing such low-latency audio signal enhancement, specifically speech enhancement, by use of deep learning frameworks with STFT based signal analysis and resynthesis. The methods and systems disclosed herein provide dual window size based audio signal enhancement, with different window size at input and output sides of audio signal processing system. The input side window is of larger length, providing the benefits of high resolution and high accuracy during analysis. The output side window is shorter in length, providing lower latency of processing and synthesis at output side. Additionally, dereverberation and beamforming operation is used during signal enhancement processes described in various embodiment disclosed herein. These and other advantages of the present disclosure would be more apparent by way of the following description of figures.

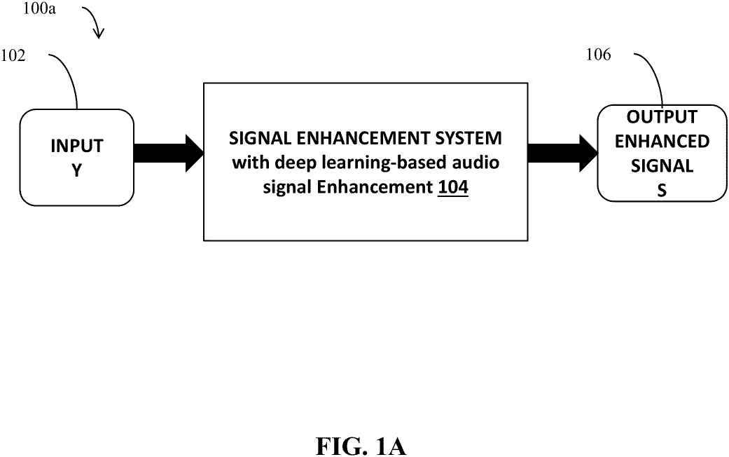

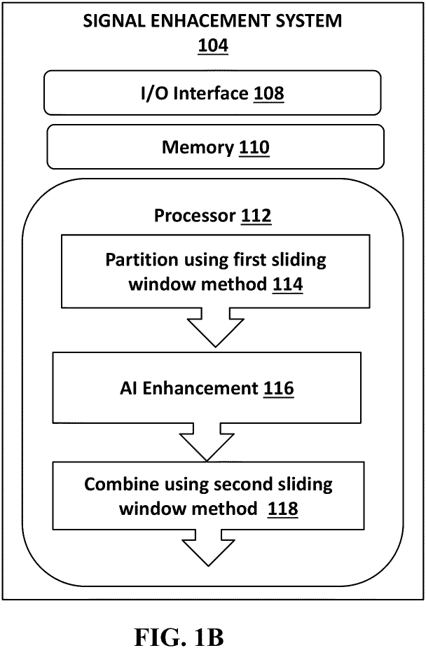

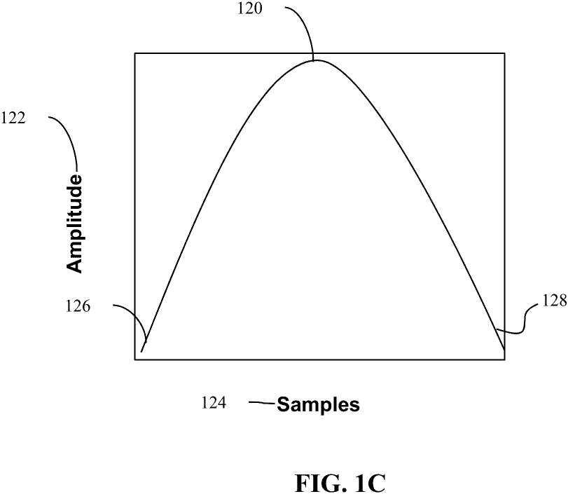

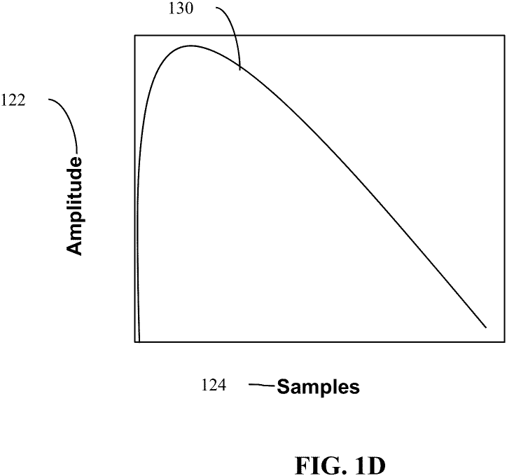

FIG. 1A illustrates a block diagram 100a of a signal enhancement system 104 for audio signal processing using deep learning based audio signal enhancement, according to some embodiments of the present disclosure. The signal enhancement system 104 is configured to receive an input mixture of audio signals 102, Y, as an input. The input mixture of audio signals 102 may be a single-channel audio signal or a multi-channel audio signal. The input mixture of audio signals 102 includes a target audio signal, which is a signal of interest among the mixture of audio signals. For example, in a room with multiple speakers, a listener may be talking to one particular speaker, and there may be other sounds in the room also, like air conditioner sound. In this case, an audio signal corresponding to the one particular speaker the listener is talking to is the target audio signal. The example outlined herein is just for describing an exemplar scenario for the application of the signal enhancement system and is not to be construed to be limiting the scope of the disclosure in any manner.

The signal enhancement system 104 uses deep learning to perform processing of the input mixture of audio signals 102 for signal enhancement. Such signal enhancement is done to ensure providing of a low latency, but high quality enhanced signal 106, S, at an output of the signal enhancement system 104. Such signal enhancement is performed by the signal enhancement system 104 with the use of deep learning techniques such as by use of artificial intelligence (AI) and deep neural networks (DNNs). The enhanced signal 106 is used in applications such as hearing aid devices and teleconferencing systems, where real-time, high quality and low latency audio signal processing is required.

To that end, the signal enhancement system 104 performs various functions which would be further illustrated with the diagram of FIG. 1B.

FIG. 1B illustrates a detailed block diagram of functions performed by the signal enhancement system 104 for audio signal processing illustrated in FIG. 1A, according to an embodiment of the present disclosure. To that end, the signal enhancement system 104 comprises different components to perform different functions. Specifically, the signal enhancement system 104 comprises an input/output I/O interface 108 configured to receive inputs at and transmit outputs from the signal enhancement system 104. For example, the I/O interface 108 includes an in input interface to receive the mixture of audio signals (Y) 102 and an output interface to generate the enhanced signal (S) 106.

The signal enhancement system 104 also includes a memory 110 for storing computer-executable instructions that comprise instructions corresponding to different functions to be performed by the signal enhancement system 104. These instructions are executed by a processor 112, which is configured to perform the different functions as a result of execution of the computer-executable instructions. For example, the computer-executable instructions include instructions that configure the processor 112 to perform one or more operations comprising: partitioning 114 the received input mixture of audio signals 102 into a sequence of input overlapping frames using a first sliding window method having a first window function with a first width, processing the sequence of input overlapping frames using an architecture of deep neural networks (DNNs) to achieve Al based or deep learning based audio signal enhancement, and combining 118 the enhanced overlapping frames using a second sliding window method having a second window function associated with a second width less than the first width. The architecture of DNNs may include a first DNN and a second DNN. The first DNN processes the partitioned sequence of input overlapping frames to generate enhanced overlapping frames. The enhanced overlapping frames are then passed to a frequency domain filter for producing frequency domain filtering output for each frame of the enhanced overlapping frames, after processing all frames up to a current frame (that is using all past knowledge of frames up to a current point in time). Then, the frequency domain filtering output for each of the processed enhanced frames is passed to the second DNN which generates a corresponding final enhanced frame for each frame of the enhanced overlapping frame. These final enhanced frames are then combined 118 using the second sliding window method. Each of these functions would be described in detail in the embodiments disclosed herein.

As is generally known, audio signals and speech signals are enhanced using time-frequency domain approaches which perform phase re-synthesis techniques for enhancement of audio signals. However, with advancement of deep learning, speech enhancement is able to leverage the advanced accuracy and low latency provided by time-frequency domain approaches based on deep learning. For this, the audio signal is first converted into time-frequency domain using known techniques such as STFT and other time-domain approaches which typically split signals into overlapped frames with a reasonably large hop length before processing.

For this, the audio signal is multiplied with a window function and then discrete Fourier Transform (DFT) is applied to each frame of the overlapped frames. Such window functions, also called sliding windows or tapering functions, are functions in which the amplitude (of the multiplied signal) tapers gradually and smoothly becomes zero towards the edges. In this way, each frame occupies a different time period, and the resulting STFT indicates the spectral content of the signal at each corresponding time period. By moving the sliding window, the spectral content of the signal over different time intervals can be observed. Therefore, the STFT is a function of time and frequency that indicates how the spectral content of a signal evolves over time. A complex-valued, 2-D array called the STFT coefficients stores the results of windowed Fourier transforms. The magnitudes of the STFT coefficients form a magnitude time-frequency spectrum, and the phases of the STFT coefficients form a phase time-frequency spectrum. The window function thus provides the tapering effect by providing a mathematical function that is zero valued outside a selected interval and is normally symmetric around a middle of the interval, usually maximum near the middle. As a result, when another function (such as the audio signal) is multiplied with the window function, the product is zero-valued outside the interval and the part that is left is the part where the two functions overlap, providing “a view through the window”.

Some common examples of such window functions include a Hann window function, a hamming window function, a Blackman Harris window function, a generalized cosine window function, and the like. For example, FIG. 1C shows an exemplar Hann window function 120. The Hann window function 120 is a bell-shaped curve where an amplitude 122 and a sample 124 value is represented along the Y-axis and the X-axis, respectively. As can be seen from FIG. 1C, the amplitude 122 of the Hann window function 120 is maximum in the middle and gradually tapers toward edges 126 and 128. Most window functions are similar bell-shaped curves. The type of window function used and a length of the window function, which is also referred to as a width of a window of the window function, affects the time-frequency resolution of the resulting STFT. Generally, the window length depends on the underlying signal to be analyzed. The window length should be small enough so that the windowed signal block/frame is essentially stationary over the window interval and large enough so that the Fourier transform of the windowed signal block provides a reasonable frequency resolution. For slow evolution signals, window length should be large, while for fast evolving signals, the window length should be small. For example, in speech signal processing, a time-domain window length of 25 ms is common.

Another parameter associated with window functions is a hop length, also referred to as a shift width or a shift length, which determines the amount of overlap between adjacent frames or blocks of the signal. If shift length is smaller than the window width, overlap exists between frames. However, if shift length is larger than the window width, no overlap exists between adjacent frames. Further, at the time of signal re-synthesis, an overlap-add operation is used to sum all the samples from overlapping frames at a particular time interval, to get the final re-synthesized signal sample. Further, latency is defined as the delay caused in to processing of the signal to arrive an output. Generally, latency is equal to the window length due to the use of overlap-add in signal resynthesis, plus the running time of processing one frame. In an example, for a typical STFT based system with a 32 ms window and an 8 ms hop size, the overlap is 75%, hence each quarter of the window is processed by 4 different windows. Thus, the latency in processing of a sample of the signal is 32 ms, as all the 4 windows in which the sample falls need to be processed, in order to recreate the sample of the signal at the output.

Further, in some embodiments, the latency in processing of the signal or a sample of the signal is defined as processing latency, which is a summation of algorithmic latency and hardware latency. The algorithmic latency is defined as latency due to due to algorithmic reasons (such as overlap-add), and the computing time needed to process one frame is defined as the hardware latency. In example discussed above, the processing latency is 32 ms+8ms = 40 ms, which is too large for some applications, like hearing aids and can lead to a poor listening experience.

In order to overcome this challenge, the signal enhancement system 104 uses different widths for windows partitioning the signal, such as the input mixture of audio signals 102 into frames and reconstructing the signal, such as the enhanced signal 106 from the frames. In this manner, the signal enhancement system 104 is able to provide more information for processing of the partitioned input mixture of audio signals 102 using DNN based architecture, having linear filtering in between two DNNs. This is possible due to larger input window size and shorter output window size.

In the previous example, the delay is 32 ms due to the need to combine all 4 frames of the input signal to recreate a quarter of a window of the input signal causing the delay of 32 ms. However, some embodiments disclosed herein are based on a realization that there is no need to wait for all 4 frames to be processed and use all 4 of them to reconstruct each sample of the output/enhanced signal 106. Instead, a fewer number of frames, e.g., just 2 frames can be used at the time of overlap-add operation for performing signal re-synthesis to provide the enhanced signal 106. To that end, some embodiments are based on realization that the width of the sliding window method for combining the frames should be less than the width of the window for partitioning the multi-channel input(audio) signal 102 into overlapping frames.

To that end, the signal enhancement system 104 is configured to use the first sliding window method for partitioning 114 the input mixture of audio signals 102 into a sequence of input overlapping frames, and to use the second sliding window method for combining the final enhanced frames. The first sliding window method is associated with the first window function having the first width. The second sliding window method is associated with the second window function having the second width. The second width is lesser than the first width. The first window function and the second window function may be selected from any of the window functions described above, including but not limited to the Hann window function, the hamming window function, the Blackman Harris window function, the generalized cosine window function, a rectangle window function, a triangle window function, and the like. To that end, each of the first sliding window method and the second sliding window method may be any of symmetric or asymmetric window functions.

In some embodiments, the first window function and the second window function may both be asymmetric window functions, such that they are not symmetrical bell curves in shape and some portions of the signal with which they are multiplied are tapered more, and some less. To that end, if a window function is considered equivalent to a weighting function, then asymmetric window functions are those window functions whose weighting functions and weighting coefficients are not symmetric about the origin.

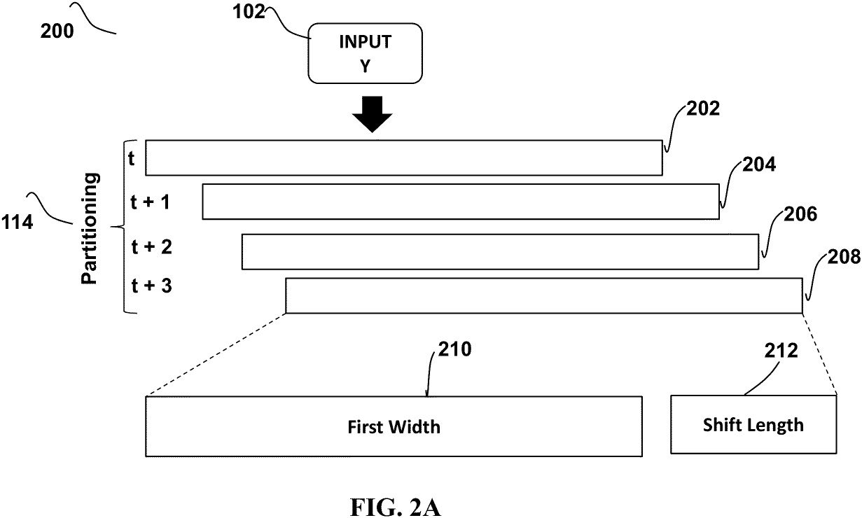

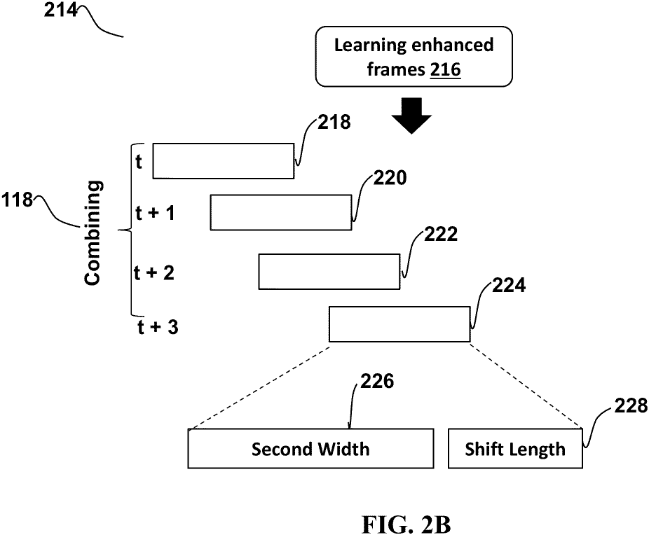

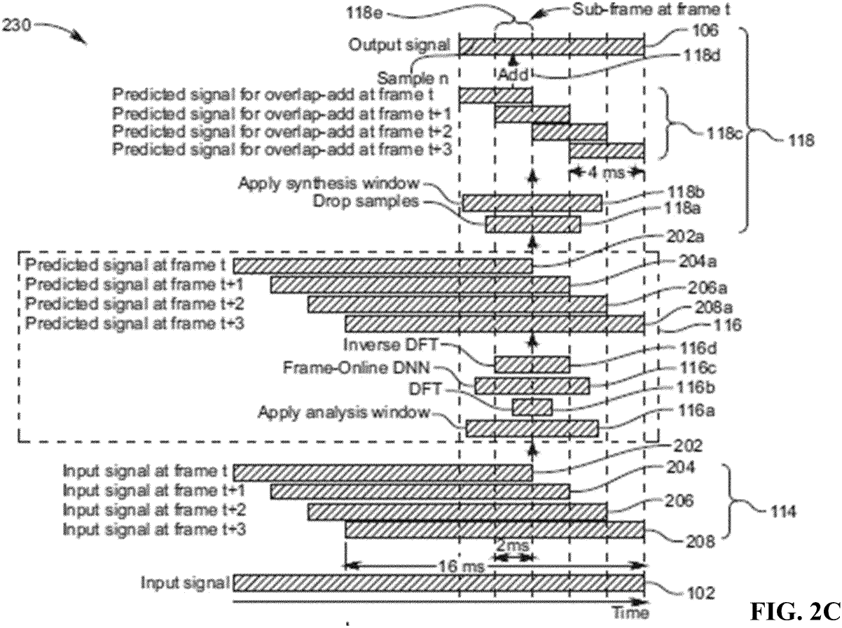

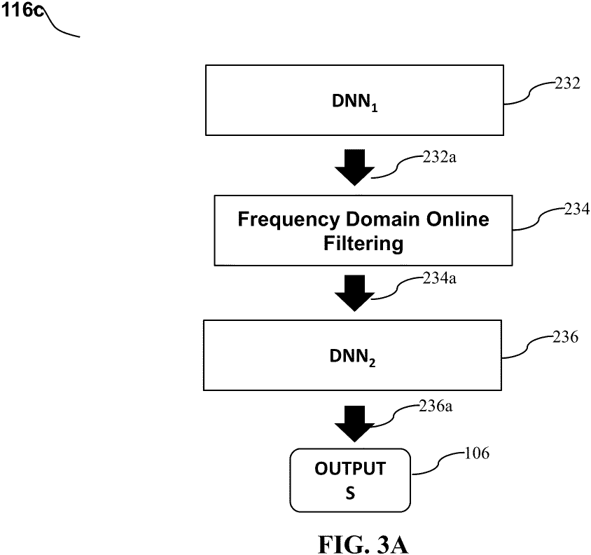

FIG. 1D illustrates an example of an asymmetric window function 130 which is not symmetrical about origin and where some samples are given more weightage than others. Irrespective of the type of window function used, whether symmetric or asymmetric, the signal enhancement system 104 uses two different window sizes at the input side and the output side, in order to achieve high frequency resolution and low latency in enhancement of the signal, such as the input mixture of audio signals 102. The concept of two windows of different sizes would be explained further in conjunction with FIG. 2A and FIG. 2B below.

FIG. 2A illustrates a schematic block diagram of steps performed during partitioning 114 of the input mixture of audio signals 102 using a first sliding window method using a first window function 200, according to embodiments of the present disclosure. The first sliding window function 200 may include any of the previously discussed window functions. The first window function 200 may be symmetric or asymmetric, without deviating from the scope of the present disclosure.

The first window function 200 is applied, such as by multiplying, with the input mixture of audio signals 102, resulting in the partitioning of the input mixture of audio signals 102 into a sequence of overlapping frames: a frame 202 at interval t, a frame 204 at interval t+1, a frame 206 at interval t+2, and a frame 208 at interval t+3. The length of each window of the window function 202, also known as first width 210 is chosen in a manner to have high frequency resolution at the input side. Further, the hop length of the first sliding window method which is related to shifting of windows between overlapping frames, also referred to herein as a shift length 212 is also selected in a manner that overlap is present between successive frames. To that end, the shift length 212 is selected to be equal to or less than 20% of the first width 210, in order to have more than at least 80% overlap between successive frames. For example, if the shift length 212 is equal to 20% of the first width, then the frame 202 overlaps with the frame 204 by 80%, and similarly for other overlapped frames.

In an example, the first width 210 is selected as at least equal to 32 milliseconds (ms), the shift length 212 at least equal to 2 ms. Thus the shift length 212 is 2/32*100 = 6.25% of the first width 210, providing more than 93% (30/32*100) overlap between any two overlapping frames in the sequence of frames 202 - 208, ensuring a high frequency resolution at the partitioning 114 step performed by the signal enhancement system 104. The overlapping frames are then enhanced at the step of Al enhancement 116 (using an architecture of neural networks) performed by the signal enhancement system 104 (the enhancement would be explained later in the description), and as a result, a corresponding final enhanced frame is generated for each overlapping frame 202-208. To that end, the processing of the partitioned input overlapping frames is done in a streaming manner. As the input mixture of acoustic signals 102, is received, it is partitioned into the sequence of input overlapping frames which are buffered. Then, as each frame, such as a current frame, gets completed, it is passed to the Al enhancement 116 module having neural network based architecture. A current frame is processed in combination with a previously formed and buffered frame (in some configurations, it could be just the last frame, but in general it would be a few recent frames, and sometimes potentially all past frames) to generate the corresponding enhanced frame. These corresponding enhanced frames are also passed through a filtering network, which produces a frequency domain filtering output for each enhanced frame in the same streaming manner as described above. Then the Al enhancement 116 is repeated for the filtering output which produces a final enhanced frame for each filtering output, again in the streaming manner.

The corresponding final enhanced frames are then combined using a second sliding window method, which would be explained in FIG. 2B.

FIG. 2B illustrates a schematic block diagram of steps performed by the signal enhancement system 104 during the combining 118 of learning enhanced overlapping frames 216 a second sliding window method having a second window function 214, according to embodiments of the present disclosure. The second window function 214 may include any of the previously discussed window functions. The second window function 214 may be symmetric or asymmetric, without deviating from the scope of the present disclosure.

The second window function 214 is applied, such as by multiplying the enhanced signal of the by the second window function 214 to provide learning enhanced frames 216, comprising a sequence of enhanced overlapping frames: a frame 218 at interval t, a frame 220 at interval t+1, a frame 222 at interval t+2, and a frame 224 at interval t+3. The length of each window of the window function 214, also known as a second length 226 is chosen in a manner to have low latency at the output side. Further, the hop length of the second sliding window method which is related to shifting of windows between overlapping frames, also referred to herein as a shift length 228 is also selected in a manner that overlap is present between successive frames. To that end, the shift length 228 is selected to be less than the second width 226. In fact, the second width 226 is selected to be at least equal to double of the shift length 228 to have a distinguishable overlap between successive frames in the enhanced overlapping frames 218-224.

In an example, the first width 210 is equal to 32 ms, the second width 226 equal to 4 ms. Thus the first width 210 is 8 times the second width. Further, the shift length is at least equal to 2 ms. In this example, the overall latency of the combining 118 process would be 4 ms.

In some embodiments, the shift length 228 is same as the shift length 212 of the first window function 200.

Further, in the above example, at the combining step 118, the overall latency is 4 ms, which is very well suited for low latency applications such as hearing aids.

In some examples, at the combining step 118, only two overlapping frames are used for synthesizing or generating a sample of the enhanced audio signal at the output 106, instead of waiting for all four frames 218-224. This further reduces the latency at the output 106 side.

Such audio signal enhancement system 104 can achieve very low-latency speech enhancement. In an example, a 32 ms window is used as the first width 210 window with 1 ms shift length 212 at the input side (such as for performing STFT), while a 4 ms window is used as the second width 226 window with a 1 ms shift length 228 for the overlap-add operation at the output 106 ( such as using iSTFT). The 32 ms window for STFT looks 4 ms ahead and 28 ms in the past. After obtaining the separated waveform at each frame, by performing inverse discrete Fourier transform (iDFT), the first 28 ms of waveform samples are discarded, and then a synthesis window is applied at the output to perform overlap-add based on the last 4 ms of waveforms at each frame. This example is illustrated further in FIG. 2C.

FIG. 2C illustrates an exemplar method 230 for performing audio signal enhancement using the signal enhancement system 104 using two different window sizes at the input 102 side and the output side 106. The method 230 is configured to provide STFT based audio signal enhancement at an algorithmic latency as low as 4 or 2 ms. This is partially achieved by combining STFT-domain, deep learning based speech enhancement with a conventional dual window approach which uses a regularly long window length for STFT at the partitioning 114 step and a shorter window length for overlap-add at the combining 118 step.

Referring to FIG. 2C, the input mixture of audio signals 102 at the input is first partitioned 114 into a sequence of input overlapping frames 202-208 using the first sliding window function 200 (shown in FIG. 2A). In the example of FIG. 2C, the first width 210 is 16 ms for performing STFT using the first window function 200, and the shift length 212 for the first sliding window method associated with the first window function 200 is 2 ms. The 16 ms first width window looks 4 ms ahead and 12 ms in the past in this case.

After obtaining the input overlapped frames, the method 230 includes processing each frame of the input overlapping frames 202-208 to perform enhancement 116 using a neural network based architecture to generate final enhanced overlapping frames 202a-208a comprising a corresponding final enhanced frame for each of the processed frame in the overlapping frames. For example, the final enhanced frame 202a corresponds to the frame 202 of the overlapping frames after being processed, the final enhanced frame 204a corresponds to the frame 204 of the overlapping frames after being processed, the final enhanced frame 206a corresponds to the frame 206 of the overlapping frames after being processed, and the final enhanced frame 208a corresponds to the frame 208 of the overlapping frames after being processed. The processing at the enhancement 116 step further includes, at 116a, applying an analysis window for performing the STFT, and then at 116b performing the DFT for each frame of the input overlapping frames 202-208 to convert the time-frequency domain signals in each frame into frequency domain for neural network based enhancement. The frequency domain frames are partitioned using the first sliding window function 200 which is of longer length, so the neural network based processing and enhancement is able to perform better with more information per frame. After obtaining the DFT separated frames, at 116c frame online DNN based processing is performed.

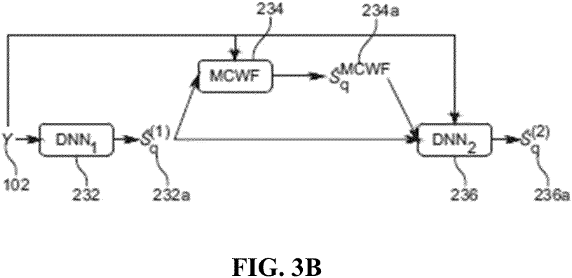

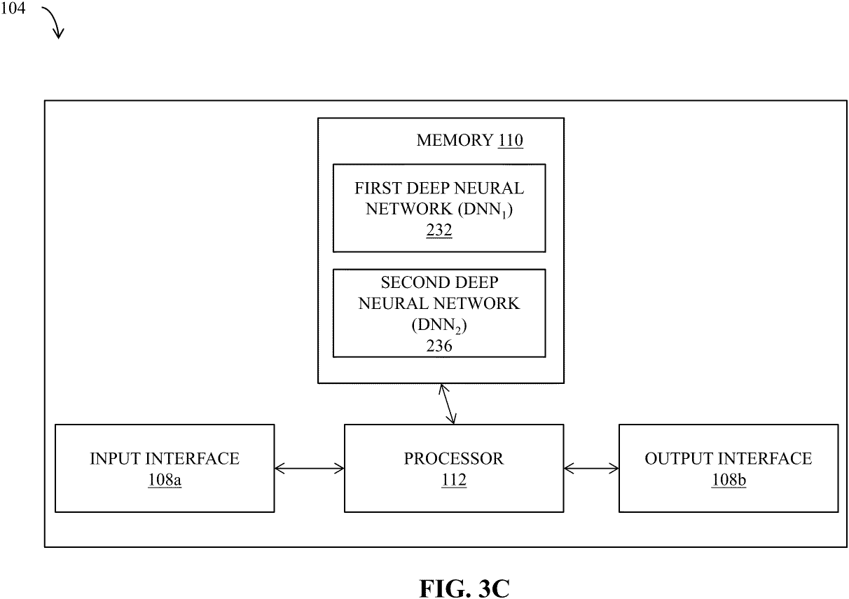

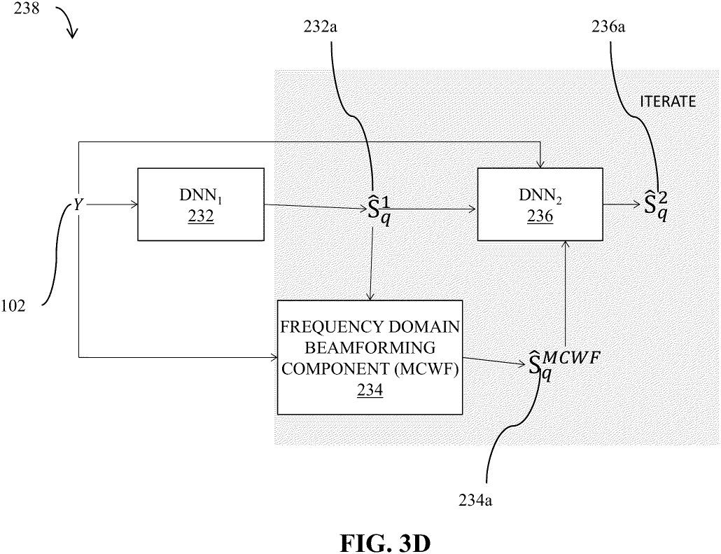

This frame-online DNN based processing would further be explained in FIG. 3A-FIG. 3D. As a result of the frame-online DNN based processing at 116c, final enhanced frames are obtained which are subjected to iDFT operation to convert frequency domain signals in each frame back into time-frequency domain for reconstruction of samples in each frame. The reconstruction is performed such as using the combining 118 step, which is done using the second sliding window function 214 having a second width 226 of 4 ms and the shift length 228 of 2 ms. The combining 118 step further includes at 118a, dropping samples in first 12 ms of the enhanced frames 202a-208a, and then, at 118b, applying a synthesis window as per the second window function 214 to synthesize a sample back from the overlapped frames 118c obtained after dropping samples from the final enhanced frames 202a-208a. The overlapped frames 118c are then added at 118d to reconstruct the samples in the output signal 106. As can be seen for a sample 118e of the output signal 106, the sample 118e corresponds to a sub-frame at time interval t and is obtained by performing overlap 118c and add 118d operations using only two sub-frames - a sub-frame at time interval t and a sub-frame at time interval t+1. Thus, at the output 106 side, each sample can be synthesized only by waiting for the next frame in the sequence, which in the current example is of 4 ms width. Therefore, the overall algorithmic latency is only 4 ms in this example, at the output 106 side. This is a highly improved performance as compared to same size window width methods, where the algorithmic latency would conventionally have been 16 ms, due to 16 ms window width at the input 102 side.

Thus, using the method 230 when used with DNN based enhancement at 116c, has several advantages. First, using a long window for STFT at partitioning 114 step leads to higher frequency resolution, meaning that there can be more estimated filters (or mask values) per frame to obtain more fine-grained audio signal enhancement. In addition, higher frequency resolution can better leverage the speech sparsity property in the T-F domain for enhancement performed signal enhancement system 104. Second, using a longer first window with first width 210 longer than the second width 226 can capture more reverberation at each frame in the overlapping frames 202-208, potentially leading to better dereverberation during the frame online DNN based processing at step 116c. In addition, it could lead to better spatial processing, as the interchannel phase patterns could be more stable and salient for longer signals. Third, STFT bases are narrowband in nature, meaning that the DNN outputs from the step 116c could be used to compute a conventional frequency-domain beamformer, whose results can be used as extra features for another DNN to better predict the target speech in case of speech processing tasks by the signal enhancement system 104.

Thus, using the signal enhancement system 104 performing the method 230 a conventional dual window size may be adapted to reduce the algorithmic latency of STFT-domain deep learning based speech enhancement. Second, the outputs from the a DNN in the processing step 116c is used for frequency-domain frame-online beamforming, and in an example (which would be discussed later) the beamforming result is fed to a second DNN for better signal enhancement. Compared with using the outputs from time-domain models for frequency-domain beamforming, the method 230 does not incur algorithmic latency because the two DNNs and the beamformer all operate in the complex T-F domain.

In an example, the method 230 can achieve comparably good or better performance than the popular Conv-TasNet technique using a similar amount of computation and at an algorithmic latency as low as 4 or 2 ms. Also, a recent dual window size study on deep learning based speaker separation, has been determined to be monaural and uses real-valued mask estimation, only reduces the algorithmic latency to 8 ms, and does not compare with time-domain models, making the method 230 performed by the signal enhancement system 104 to be much superior.

To achieve very low-latency separation, the DNN models, trained using regular 32 ms window and 8 ms hop sizes, are configured to run at smaller hop sizes such as 1, 2 and 4 ms, and smaller output window sizes such as 2, 4 and 8 ms at inference time. In other words, a proper hop size can be selected and also proper output window size at run time, without re-training the model.

In an example, the method 230 uses a gain normalization mechanism inside the DNNs for the frame online DNN based processing at step 116c to deal with random gains in the input 102 mixture of multi-channel audio signals, and it is observed that the performance of the signal enhancement system 104 is not sensitive to changes in input gains.

The frame-online DNN based signal enhancement performed at step 116c would be described in detail in conjunction with FIG. 3A - FIG. 3E.

FIG. 3A illustrates an example of processing 116c of each frame of the partitioned overlapping frames 202-208 using an architecture having two neural networks, according to an embodiment. The architecture of FIG. 3A shows two neural networks as an example implementation. However, any number of equivalent neural networks more than one may be possible without deviating from the scope of the present disclosure.

In an example, the input mixture of audio signals 102 which is partitioned 114 into the sequence of input overlapping frames 202-208 using the first window function 200, corresponds to an utterance of a speaker recorded in noisy reverberant conditions by a P-microphone array. The physical model of such a signal in the STFT domain can be formulated as:

$$\begin{matrix}\text{Y} \left(\text{t; f}\right) = \text{X} \left(\text{t; f}\right) + \text{V} \left(\text{t; f}\right) \\ = \text{S} \left(\text{t; f}\right) + \text{H} \left(\text{t; f}\right) + \text{V} \left(\text{t; f}\right) ;\end{matrix} \qquad \text{(1)}$$

where Y(t; f), V(t; f), X(t; f), S(t; f) and H(t; f) ∈ ℂ^{P} respectively denote an STFT vectors of a mixture of audio signals corresponding to the input mixture of audio signals 102, reverberant noise, reverberant target speech, direct-path and non-direct signals of a target speaker at time t and frequency f. In the rest of the description, when dropping t and f from the notation, corresponding spectrograms are referred as an example. Based on the input Y, the target speaker’s direct-path signal captured at a reference microphone q, i.e., Sq may be recovered using the signal enhancement system 104.

The signal enhancement system 104 executing the signal enhancement method 230 is configured to perform the processing 116c of each frame of the overlapping frames 202-208, but in view of the historically received frames or frames stored in memory during buffering until a current time, using the architecture of FIG. 3A comprising at least a first deep neural network DNN; 232, a frequency domain online linear filtering component 234, and a second deep neural network DNN₂ 236. Each frame of the overlapping frames 202-208, represented in the form of the mixture Y shown in equation (1), is submitted to the DNN; 232. As a result, a corresponding intermediate representation 232a for each frame is generated. The intermediate representation of each frame 232a corresponds to an enhanced overlapping frame for each corresponding input overlapping frame. This intermediate representation 232a of the enhanced overlapping frames is then passed to the frequency domain online linear filtering component 234 to generate a frequency domain filtering output 234a for the intermediate representation 232a of each frame of the enhanced overlapping frames. Further, the frequency domain filtering output 234a is submitted to the DNN₂ 236, to generate the corresponding final enhanced frame 236a for each frame of the input overlapping frames 202-208. The final enhanced overlapping frames 236a are then combined 118 using the second window function 214, to produce the output 106 signal.

In an example, the intermediate representation 232a corresponds to producing of a first estimate of the intermediate representation 232a for each frame of the partitioned input overlapping frames 202-208 using the DNN; 232. This intermediate representation 232a is the used to estimate a filter modeling a room impulse response (RIR) for the first estimate of the intermediate representation 232a for each frame. Thereafter, a mixture with reduced reverberation is obtained for the intermediate representation 232a of each frame by removing the result of applying the filter to the intermediate representation 232a for each frame from the received input mixture of audio signals 102. This mixture with reduced reverberation is then submitted to the DNN₂ 236 produce a second estimate of the intermediate representation 232a for each frame and the second estimate of the intermediate representation 232a for each frame may be outputted via an output interface, such as the I/O interface 108 of the signal enhancement system 104 shown in FIG. 1B.

The frequency domain filtering output for each frame of the enhanced overlapping frames may be a causal linear filtering output generated by a causal linear filter, such as the estimated filter based on a convolutive prediction.

The architecture shown in FIG. 3A, with two DNNs- the DNN; 232, the DNN₂ 236 and the frequency domain online filtering 234 component is advantageous as compared to past approaches based on use of dual window sizes in audio signal processing applications. Firstly in the architecture and processing 116c of FIG. 3A, the output 232a from the DNN; 232 is used for frequency-domain frame-online beamforming using the frequency domain online filtering 234 component, and the beamforming result 234a is fed to the DNN₂ 236 for better enhancement (i.e., post-filtering). This beamforming followed by post-filtering approach produces clear improvements in audio signal enhancement applications over just using one DNN (i.e., not using any beamforming and post-filtering).

Further, the processing 116c is based on the realization that, since the two DNNs (232 and 236) and the beamformer (234) all operate in the complex T-F domain, this processing 116c does not incur additional algorithmic latency. In contrast, known time-domain models cannot be straightforwardly combined with frequency domain beamforming without incurring extra algorithmic latency. This comparison demonstrates that one advantage of performing very low-latency enhancement in the STFT domain, using the architecture shown in FIG. 3A, is the integration with frequency-domain beamforming. In an example, the beamforming is done using linear filtering.

For example, the linear filter may be a causal linear filter generating causal linear filtering output.

For example, the causal linear filter may be multi-channel wiener filter (MCWF). The architecture using the MCWF is illustrated in FIG. 3B.

FIG. 3B shows an example architecture of AI or neural network based signal enhancement 116 performed by the signal enhancement system 104 at the processing step 116c shown in FIG. 3A, according to an embodiment using the multi-channel Wiener filter (MCWF). As shown in FIG. 3B, the input mixture of audio signals 102, is used for recovering a target speaker’s direct-path signal captured at a reference microphone q, i.e., Sq. In an example, the corresponding time-domain signal of Sq, denoted as sq, is used as the reference signal for metric computation. In this example, early reflections are not considered as part of target speech. In multi-microphone cases, the same array geometry is used for training and testing phases of the neural networks DNN₁ 234 and DNN₂ 236. Using the real and imaginary (RI) components of multiple input signals as input features, the DNNs -DNN₁ 234 and DNN₂ 236 are trained sequentially based on single- or multi-microphone complex spectral mapping to predict the RI components of Sq. The estimated speech in the form of the first estimate

$${\hat{\text{S}}}_{q}^{1}$$

of the intermediate representation 232a by the DNN; 234 is used to compute, at each frequency, the MCWF for the target speaker to perform the frequency domain online beamforming 234 and generate the beamforming output 234a

$${\hat{\text{S}}}_{q}^{M C W F} .$$

Further, the DNN₂ 236 concatenates the RI components of the beamforming output 234a

$${\hat{\text{S}}}_{q}^{M C W F} ,$$

the outputs 232a

$${\hat{\text{S}}}_{q}^{1}$$

of DNN₁ 234, and the mixture of audio signals 102 Y as features to further estimate the RI components of the Sq. This estimate may correspond to the second estimate

$${\hat{\text{S}}}_{q}^{2}$$

of the intermediate representation 232a and is the enhanced frame 236a corresponding to the overlapping frame at the input.

In an example, the DNN; 234, the DNN₂ 236 and the MCWF module 234 are all designed to be frame-online, such that the two-DNN system shown in FIG. 3A and FIG. 3B may be easily plugged into the AI enhancement 116 part performing the frame online DNN based processing 116c of the method 230 shown in FIG. 2C, to achieve audio signal enhancement with exceptionally low algorithmic latency. An example architecture of the signal enhancement system 104 with plugged in two-DNN system of FIG. 3A and FIG. 3B is shown in FIG. 3C.

In some example embodiments, the signal enhancement system 104 includes an input interface 108a which is part of the I/O interface 108 shown in FIG. 1B, the memory 110 storing the first deep neural network (DNN₁) 232 and the second deep neural network (DNN₂) 234, the processor 112, and an output interface 108b which is part of the I/O interface 108 shown in FIG. 1B.

The input interface 108a is configured to receive a mixture of acoustic signals including the target direct-path signal and reverberations of the target direct-path signal. In some example embodiments, the input interface 108a may be configured to connect with at least a microphone of the signal enhancement system 104, or an array of microphones of the signal enhancement system 104.

The processor 112 submits the mixture of acoustic signals including the target direct-path signal 102 and the reverberations to the DNN₁ 232. The DNN; 232 outputs a first estimate of the target direct-path signal corresponding to the intermediate representation 232a. In a multiple speaker scenario, generating sound signals in an environment, a target direct-path signal corresponding to each of the multiple speakers is estimated by the DNN; 232. The DNN; 232 may determine the corresponding estimate 232a of the target direct-path signal either one by one or simultaneously for each of the multiple speakers.

The first estimate 232a of the target direct-path signal is used together with the received mixture of acoustic signals 102 to estimate a filter, such as the filter 234, modeling a room impulse response (RIR) for the first estimate 232a of the target direct-path signal. The RIR is an impulse response of a room, e.g., the environment, between a source of sound (e.g., a speaker) and a microphone.

In some embodiments, the filter 234 modeling the RIR may be outputted via the output interface 108b.

In some embodiments, the filter 234 modeling the RIR for the first estimate 232a of the target direct-path signal corresponding to input mixture of acoustic signals 102 is estimated such that, when it is applied to the first estimate 232a of the target direct-path signal, a corresponding result is closest to a residual between the mixture of acoustic signals 102 and the first estimate 232a of the target direct-path signal according to a distance function. In some embodiments, the distance function may correspond to a weighted distance with a weight at each time-frequency point in the time-frequency domain. The weight may be determined by one or a combination of the received mixture of acoustic signals 102 and the first estimate 232a of the target direct-path signal. In an example embodiment, the distance function may be based on a least-square distance. As a result of applying this filter 234 modeling the RIR, a dereverberation output corresponding to at the result is closest to a residual between the mixture of acoustic signals 102 and the first estimate 232a of the target direct-path signal according to a distance function is obtained. This dereverberation output based on such weighted distance function is obtained using a weighted prediction error method in an embodiment.

In another embodiment, the dereverberation output is obtained based on a convolutive prediction. The convolutive prediction is a linear prediction method for speech dereverberation in reverberant conditions, which relies on source estimates obtained by deep neural networks (DNNs) and exploits a linear filter structure between the source estimate and the reverberant version of the source signal within the observed input signal.

The convolutive prediction corresponds to a forward convolutive prediction (FCP) that forwardly filters the first estimate 232a of the target direct-path signal obtained by the DNN; 232. The forward filtering may estimate the filter 234 by solving the following minimization problem

$${\text{argmin}}_{{\text{g}}^{′} \left(\text{f}\right)} {\sum }_{\text{t}} \frac{{\left|\text{Y} \left(\text{t,f}\right) - {\hat{\text{S}}}_{{\text{DNN}}_{\text{b}}} \left(\text{t,f}\right) - {\text{g}}^{′} {\left(\text{f}\right)}^{\text{H}} {\tilde{\hat{\text{S}}}}_{{\text{DNN}}_{\text{b}}} \left(\text{t,f}\right)\right|}^{2}}{\hat{\text{λ}} \left(\text{t,f}\right)} , \qquad \text{(3)}$$

~ where Ŝ_{DNN}_{b} (t, f) = [Ŝ_{DNN}_{b} (t, f), Ŝ_{DNN}_{b} (t - 1, f), ..., S_{DNN}_{b}(t - K + 1, f)]^{T}. The dereverberation result, which is a mixture with reduced reverberation of the target direct-path signal, is computed as Y(t,f) - g̅′(f)^{H}S̅_{DNNb}(t,f), where the subtracted term g̅′(f)^{H}S̅_{DNNb}(t,f), is considered as the reverberation estimated by forward filtering. Ŝ_{DNN}_{b} indicates an estimate of the target direct-path signal obtained by a DNN DNN_{b}, such as DNN; 232. The first estimate (Ŝ_{DNN}_{b}) 232a of the target direct-path signal is reverberated using a filter per frequency to find delayed and decayed copies of the target direct-path signal. Such copies are repetitive signals of the first estimate 232a that is considered as reverberation of the target direct-path signal.

The filter (g′ (f)) is then applied to the first estimate of the target direct-path signal and the result is subtracted from the mixture of acoustic signals 102. This results in removing both early reflections and late reverberation of the target direct-path signal, while leveraging both magnitude and phase of the first estimate by the DNN; 232 in the filter estimation. This produces the dereverberation output for each enhanced overlapping frame, by the frequency domain filter 234.

In some embodiments, the dereverberation output is produced using a weighted prediction error (WPE) method. The WPE method computes an inverse linear filter based on variance-normalized delayed linear prediction. The computed linear filter is applied to past observations of the reverberant and potentially noisy mixture input signal to estimate late reverberation of a target source signal within the mixture input signal from the past observations of reverberation for the dereverberation. The estimated late reverberation is subtracted from a mixture of acoustic signals that is received from different sources, to estimate a target speech signal in the mixture of acoustic signals. In some embodiments, the filter may also be estimated with a time-varying power spectral density (PSD) of the target speech signal. The PSD is a distribution of power of a signal over frequency ranges of the signal. Such linear filter may be iteratively estimated using WPE in an unsupervised manner.

By any method described above, when the result of the application of the filter 234 to the first estimate 232a of the target direct-path signal is removed from the mixture of acoustic signals 102, a mixture with reduced reverberation of the target direct-path signal, such as 234a, is obtained. The mixture with reduced reverberation 234a of the target direct-path signal is given as an input to the DNN₂ 236. The DNN₂236 generates a second estimate 236a of the target direct-path signal. In an example, the second estimate 236a of the target direct-path signal is outputted via the output interface 108b.

In an example, the second estimates of all the frames are combined using the second window method described in FIG. 2B.

Likewise for the process discussed above may be repeated for each speaker of the multiple speakers in an environment.

In an example, the architecture of FIG. 3C is used for dereverberation of speech signals. For example, output of the DNN; 232, such as the first estimate 232a of the target direct-path signal of the input 102, and the mixture with reduced reverberation obtained using filter 234 may be leveraged for the dereverberation of speech signals. To that end, the first estimate 232a and the mixture with reduced reverberation obtained using filter 234, may be inputted to the DNN₂ 236 to output a second estimate of the target direct-path signal. The output generated by the DNN₂ 236, such as the second estimate may be better than the output of the DNN; 232 as the inputs to the DNN₂ 236 (i.e., the first estimate 232a and the mixture with reduced reverberation obtained using filter 234) are more refined than input of the DNN; 232. For instance, the first estimate 232a and the mixture with reduced reverberation obtained using filter 234 outputted by the DNN; 232 may have less interferences. When these first estimate 232a and the mixture with reduced reverberation obtained using filter 234 with the less interferences are processed by the DNN₂ 236, the corresponding output 236a (i.e., the second estimate) may be better than the output of the DNN; 232. The second estimate generated by the DNN₂ 236 may thus be used to perform another iteration of convolutive prediction to obtain a second filter and a second mixture with reduced reverberation, and the second mixture with reduced reverberation may be inputted together with the second estimate to the DNN₂ 236 to produce a refined output.

In some example embodiments, corresponding RIR of each speaker, may be estimated by solving a linear regression problem per frequency in a time-frequency or time domain. To that end, a filter modeling the RIR may be used to identify delayed and decayed copies of the target direct-path signal of the speaker at the input 102. The delayed and decayed copies that are repetitive patterns due to reverberation may be removed from the received mixture of acoustic signals 102. To that end, the filter modeling the RIR may be equivalent to the filter 234 which is applied to the first estimate 232a to output the result 234a. The result 234a may be closest to a residual between the mixture of the acoustic signals 102 and the first estimate 232a of the target direct-path signal based on a distance function, such as a weighted least-square distance function. When the result 234a is removed from the mixture of acoustic signals 102, a mixture with reduced reverberation is obtained.

The delayed and decayed copies may correspond to late reverberation and early reflections of the target direct-path signal. These early reflections and the late reverberation may be identified from the RIR modeled by the filter estimate 232a.

FIG. 3D shows a schematic diagram of an architectural representation 238 for enhancement of speech signals, according to embodiments of the present disclosure. As shown in FIG. 3D, the architectural representation 238 includes the DNN; 232, the DNN₂ 236 and the frequency domain online beamforming 234 component of processing. The architecture 238 corresponds to the processing step 116c shown in FIG. 3A.

The DNN; 232 provides DNN-estimated target RI components in the form of the first estimate 232a, based on which the frequency domain online beamforming component estimates the online multi-channel Wiener filter (MCWF) 234a to enhance target speech received as the multi-channel audio input signal 102 (Y). The MCWF 234a is computed per frequency, leveraging the narrow-band property of STFT. Although the beamforming result of such a filter usually does not show better scores in terms of enhancement metrics than the immediate DNN outputs, it can provide complementary information to help the DNN₂ 236 obtain better enhancement results.

Further, using the architecture of FIG. 3D (and also equivalently FIG. 3A and FIG. 3B) frame-online frequency-domain beamforming can be easily integrated with STFT-domain DNNs to improve the overall signal enhancement performed by the signal enhancement system 104, while not incurring any algorithmic latency.

In some embodiments, even more advanced beamformers, or dereverberation algorithms such as WPE may be used to achieve even better enhancement than MCWF, without deviating from the scope of the present disclosure.

The MCWF 234 computes a linear filter per T-F unit or per frequency to project the mixture (Y) to target speech. Assuming the target speaker does not move within each utterance and based on the DNN-estimated target speech

$${\hat{\text{S}}}_{q}^{1} ,$$

a time invariant MCWF per frequency is computed through the following minimization problem:

$${min}_{\text{w} \left(f ; q\right)} {\sum }_{i} {\left|{\hat{S}}_{q}^{\left(\text{I}\right)} \left(t , f\right) - \text{w} {\left(f ; q\right)}^{\text{H}} \text{Y} \left(t , f\right)\right|}^{2} , \qquad \text{(2)}$$

where q denotes the reference microphone and w(f; q) ∈ℂ^{P} is a P-dimensional filter. Since the objective is quadratic, a closed-form solution is available

$$\begin{matrix}\hat{\text{w}} \left(f ; q\right) = {\left({\hat{\text{Φ}}}^{\left(y y\right)} \left(f\right)\right)}^{- 1} {\hat{\text{Φ}}}^{\left(y a\right)} \left(f\right) {\text{u}}_{y} , \\ {\hat{\text{Φ}}}^{\left(y y\right)} \left(f\right) = {\sum }_{t} \text{Y} \left(t , f\right) \text{Y} {\left(t , f\right)}^{\text{H}} , \\ {\hat{\text{Φ}}}^{\left(y y\right)} \left(f\right) = {\sum }_{t} \text{Y} \left(t , f\right) {\hat{\text{S}}}^{\left(1\right)} {\left(t , f\right)}^{\text{H}} ,\end{matrix} \qquad \text{(3) - (5)}$$

where Φ̅^{(yy)}(f) denotes the observed mixture spatial covariance matrix, Φ̅^{(ys}⁾(f) the estimated covariance matrix between the mixture and the target speaker, and u_{q}is a one hot vector with element q equal to one. Notice that it is not needed to first fully compute the matrix Φ̅^{(ys)}(ƒ) and then take its qth column by multiplying it with u_{q}, because

$${\hat{\text{Φ}}}^{\left(y a\right)} \left(f\right) {\text{u}}_{g} = {\sum }_{t} \text{Y} \left(t , f\right) {\left({\hat{S}}_{q}^{\left(1\right)} \left(t , f\right)\right)}^{∗} , \qquad \text{(6)}$$

where (.)* computes complex conjugate. The beamforming result 234a is computed as

$${\hat{\text{S}}}_{q}^{M C W F}$$

given by:

$${\hat{S}}_{q}^{\text{MCWF}} \left(t , f\right) = \hat{\text{w}} {\left(f ; q\right)}^{\text{H}} \text{Y} \left(t , f\right) . \qquad \text{(7)}$$

Some embodiments are based on realization that the DNN-estimated magnitude and phase may both be used for computing the beamformer 234 and DNNs are used to estimate the target speech at the reference microphone q.

Differently from Eqs. (3)-(5), in the frame-online beamforming setup of FIG. 3D, the statistics are accumulated online, and the beamforming output 234a at each time step is computed as:

$$\begin{matrix}\hat{\text{w}} \left(t , f ; q\right) = {\left({\hat{\text{Φ}}}^{\left(y y\right)} \left(t , f\right)\right)}^{- 1} {\hat{\text{Φ}}}^{\left(y a\right)} \left(t , f\right) {\text{u}}_{q} , \\ {\hat{\text{Φ}}}^{\left(y y\right)} \left(t , f\right) = {\hat{\text{Φ}}}^{\left(y y\right)} \left(t - 1 , f\right) + \text{Y} \left(t , f\right) \text{Y} {\left(t , f\right)}^{\text{H}} , \\ {\hat{\text{Φ}}}^{\left(y a\right)} \left(t , f\right) = {\hat{\text{Φ}}}^{\left(y a\right)} \left(t - 1 , f\right) + \text{Y} \left(t , f\right) {\hat{\text{S}}}^{\left(1\right)} {\left(t , f\right)}^{\text{H}} ,\end{matrix} \qquad \text{(8) - (10)}$$

with Φ̅^{(yy)}(0, ƒ) and Φ̅^{(ys)}(0, ƒ) initialized to be all-zero. Based on the online time-varying filter ŵ (t,ƒ; q), the beamforming result is obtained as:

$${\hat{S}}_{q}^{\text{MC} \left|\text{WF}\right)} \left(t , f\right) = \hat{\text{w}} {\left(t , f ; q\right)}^{\text{H}} \text{Y} \left(t , f\right) . \qquad \text{(11)}$$

In an example, in a frame-online setup, Φ̅^{(yy)}(t)⁻¹ in Eq. (8) can be computed iteratively according to the Woodbury formula, i.e.,

$$\begin{matrix}{\hat{\text{Φ}}}^{\left(y y\right)} {\left(t\right)}^{- 1} = {\left({\hat{\text{Φ}}}^{\left(y y\right)} \left(t - 1\right) + \text{Y} \left(t\right) \text{Y} {\left(t\right)}^{\text{H}}\right)}^{- 1} \\ = {\hat{\text{Φ}}}^{\left(y y\right)} {\left(t - 1\right)}^{- 1} \\ - \frac{{\hat{\text{Φ}}}^{\left(y y\right)} {\left(t - 1\right)}^{- 1} \text{Y} \left(t\right) \text{Y} {\left(t\right)}^{\text{H}} {\text{Φ}}^{\left(y y\right)} {\left(t - 1\right)}^{- 1}}{1 + \text{Y} {\left(t\right)}^{\text{H}} {\text{Φ}}^{\left(y y\right)} {\left(t - 1\right)}^{- 1} \text{Y} \left(t\right)} ,\end{matrix} \qquad \text{(12)}$$

where the frequency index f is dropped to make the equation less cluttered. This way, expensive matrix inversion at each T-F unit is avoided in the frame-online case.

Some embodiments are based on realization that the architecture of FIG. 3D includes two DNNs - DNN₁ 232 and DNN₂ 236 and an MCWF 234 in between. Since the DNNs and beamformer all operate in the complex T-F domain, without going back and forth to the time domain, the same STFT resolution, corresponding to the first window function 200, may be used for all of them to obtain a two-DNN system with a low algorithmic latency. However, conventional techniques are based on combination of time-domain models with beamforming and have to switch back and forth to the time domain. Given a small shift width 212 (say 2 ms), a regular, large first width 210 (for example 16 ms) may be used for STFT to have a reasonably high frequency resolution for frequency-domain beamforming 234. To re-synthesize

$${\hat{\text{S}}}_{q}^{2} ,$$

a time-domain signal, in an example the last 4 ms of the 16 ms signals produced by iDFT (such as at combining 118 step of method 230) are used at each frame for overlap-add, following the procedure illustrated in FIG. 2C. The resulting signal enhancement system 104 has an algorithmic latency of 4 ms, even though the STFT spectrograms are extracted using a window size of 16 ms.

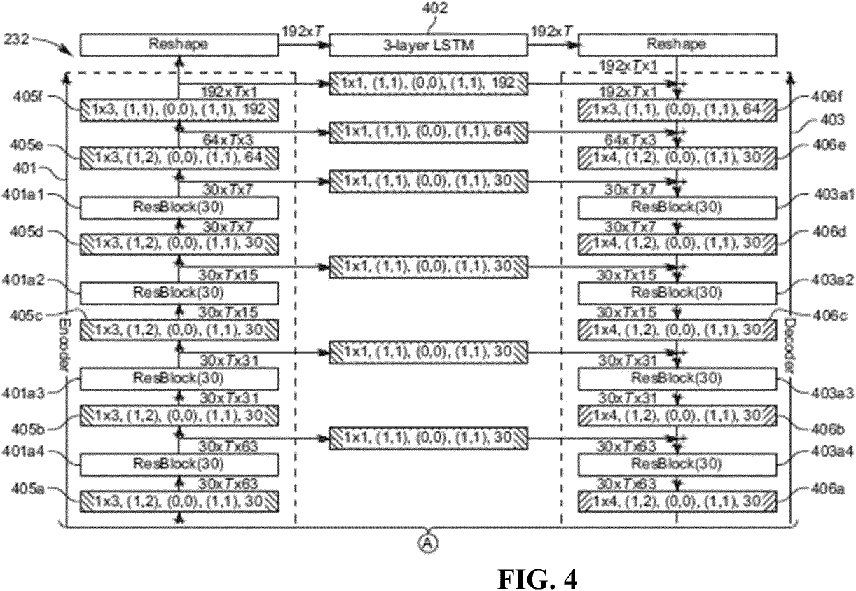

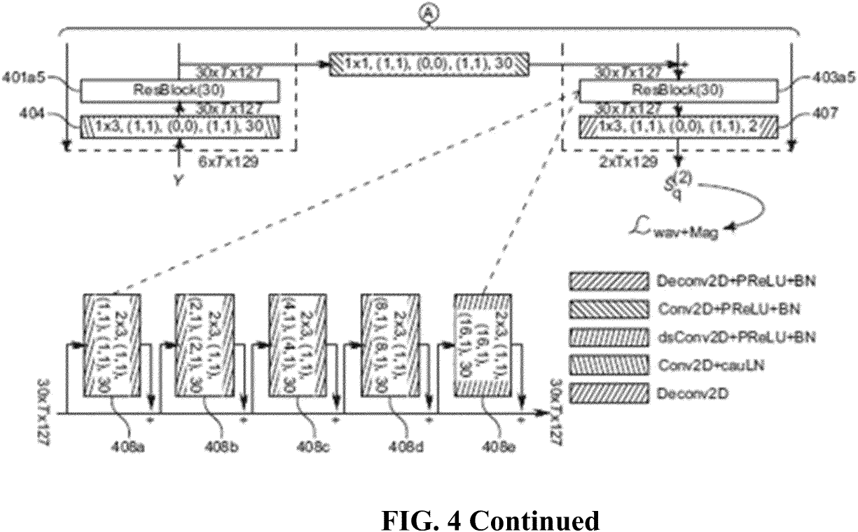

Thus the signal enhancement system 104 is able to perform DNN based low-latency audio signal enhancement. The architecture of the two DNNs used in the signal enhancement performed by the signal enhancement system 104 is exemplarily illustrated in FIG. 4.

FIG. 4 illustrates a schematic diagram depicting a network architecture 400 for each of the two DNNs - DNN₁ 232 and DNN₂ 236 used in the signal enhancement system 104, according to some other embodiments of the present disclosure. The network architecture is only one of the exemplar architectures that are used for illustration purpose. Any other suitable neural network architecture may equivalently be used, without deviating from the scope of the present disclosure.

Each of the two DNNs - DNN₁ 232 and DNN₂ 236 are trained to do complex spectral mapping, where the real and imaginary (RI) components of multiple signals are concatenated as input for DNNs to predict the target RI components at a reference microphone. Further, each of the two DNNs - DNN₁ 232 and DNN₂ 236 train through the dual window size approach and define their loss function on the re-synthesized signals and operate with dramatically reduced the per-frame amount of computation of the DNN models known previously.

Each of the two DNNs - DNN₁ 232 and DNN₂ 236 is based on long short-term memory (LSTM) and ResUNet components illustrated in FIG. 4.

FIG. 4 illustrates the architecture of DNN₁ 232. The DNN₁ 232 comprises a long short-term memory (LSTM) 402 network clamped by a U-Net comprising an encoder 401 and a decoder 403. Residual blocks are inserted at multiple frequency scales in the encoder 401 and the decoder 403 of the U-Net. For example, residual blocks 401a1 - 401a5 are inserted at multiple frequency scales in the encoder 401, and residual blocks 403a1-403a5 are inserted at multiple frequency scales in the decoder 403. The motivation of this network design is that U-Net can maintain fine-grained local structure via its skip connections and model contextual information along frequency through down- and up-sampling, LSTM 402 can leverage long-range information, and residual blocks can improve discriminability while making large networks easier to train. The DNN₁ 232 is configured to stack the RI components of different input and output signals as features maps in the network input and output. The DNN₁ 232 and the DNN₂ 236 only in their network input. The DNN₁ 232 uses the RI components of Y to predict the RI components of Sq, and the DNN₂ 236 additionally uses as input the RI components of

$${\hat{\text{S}}}_{q}^{1}$$

and the beamforming result

$${\hat{\text{S}}}_{q}^{M C W F} .$$

The encoder 401 contains one two-dimensional (2D) convolution 404 followed by causal layer normalization (cauLN) for each input signal, and six convolutional blocks: a convolutional block 405a, a convolutional block 405b, a convolutional block 405c, a convolutional block 405d, a convolutional block 405e, and a convolutional block 405f (referred to hereinafter as convolutional blocks 405a-405f). Each convolutional block comprises 2D convolution, parametric ReLU (PReLU) nonlinearity, and batch normalization (BN), for down-sampling.

The LSTM 402 contains three layers, each with 300 units.

The decoder 403 includes six blocks of 2D deconvolution: a deconvolutional block 406a, a deconvolutional block 406b, a deconvolutional block 406c, a deconvolutional block 406d, a deconvolutional block 406e, and a deconvolutional block 406f (referred to hereinafter as deconvolutional blocks 406a - 406f) with PReLU, and BN, and one 2D deconvolution block 407 for up-sampling.

Each residual block in the encoder 401 and the decoder 403 contains five depthwise separable 2D convolution (denoted as dsConv2D) blocks: a dsConv2D block 408a, a dsConv2D block 408b, a dsConv2D block 408c, a dsConv2D block 408d, and a dsConv2D block 408e (referred to hereinafter as dsConv2D blocks 408a-408e). In these dsConv2D blocks 408a-408e the dilation rate along time are respectively 1, 2, 4, 8 and 16. Linear activation is used in the output layer to obtain the predicted RI components.

In the architecture of the DNN; 232 shown in FIG. 4, all the convolution and normalization layers are causal (i.e., frame-online) at run time. The DNN₁ 232 uses 1 × 3 or 1 × 4 kernels along time and frequency for the down- and up-sampling convolutions. The residual blocks use causal 2 × 3 convolutions.

The architecture of the DNN; 232 illustrated in FIG. 4 has several advantages. This architecture provides dramatically reduced amount of computations and number of trainable parameters. This is a very effective and superior computational performance parameter achieved by the architecture disclosed herein.

In some example embodiments, the mixture of audio signals 102 may be from the single microphone or the array of microphones. To that end, the DNNs, such as the DNN₁ 232 and the DNN₂ 236 may be trained based on a spectral mapping corresponding to the single microphone and the array of microphones. The spectral mapping trains the DNN₁ 232 to predict real and imaginary (RI) components (i.e., frequency) of an estimate, e.g., the first estimate 232a of the input mixture of audio signals 102 from the RI components of the input mixture of audio signals 102. The RI components of the input mixture of audio signals 102and the RI components of the first estimate 232a may be inputted to the DNN₂ 236 to predict a second estimate of the target the input mixture of audio signals 102. The DNN; 232 may be pretrained using a training dataset of mixtures of acoustic signals and corresponding reference target direct-path signal in the training dataset.

In some embodiments, the pretraining of the DNN; 232 may be performed by minimizing a loss function. The loss function may include one or a combination of a distance function that is defined based on the RI components of the target direct-path input mixture of audio signals 102 in a first time-frequency domain and RI components of a reference target direct-path signal in the first time-frequency domain. The reference target direct-path signal may be obtained from a training dataset of utterances, and corresponding reverberant mixtures may be obtained by convolving the reference target direct-path signal with recorded RIRs or synthetic RIRs and summing with other interference signals. The distance function may be defined based on a magnitude obtained from the RI components of the estimated target direct-path signal in the first time-frequency domain and a corresponding magnitude of the reference target direct-path signal.

In an alternative embodiment, the distance function may be defined based on a reconstructed waveform obtained from the RI components of the estimated target direct-path signal in the first time-frequency domain by reconstruction in the time domain and a waveform of the reference target direct-path signal. The distance function may also be defined based on the RI components in the complex time-frequency domain obtained by transforming the reconstructed waveform further in a second time-frequency domain and the RI components of the reference target direct-path signal in the second time-frequency domain. The distance function may also be defined based on a magnitude obtained from the RI components in the second time-frequency domain obtained by transforming the reconstructed waveform in the second time-frequency domain and the corresponding magnitude of the reference target direct-path signal in the second time-frequency domain.

The loss function on the predicted RI components may be defined as,

$$\begin{matrix}{L}_{R I + M a g} = {\left‖{\hat{R}}_{q}^{\left(1\right)} - R e a l \left({S}_{q}\right)\right‖}_{1} + {\hat{I}}_{q}^{\left(1\right)} - {\left‖I m a g \left({S}_{q}\right)\right‖}_{1} + \\ {\left‖\sqrt{{\hat{R}}_{q}^{{\left(1\right)}^{2}} + {\hat{I}}_{q}^{{\left(1\right)}^{2}}} - \left|{S}_{q}\right|\right‖}_{1}\end{matrix} \qquad \text{(13)}$$

Where,

$${\hat{R}}_{q}^{\left(1\right)}$$

and

$${\hat{I}}_{q}^{\left(1\right)}$$

are the predicted RI components produced by the DNN₁ 232, Real (·) and Imag(·) extract RI components, and ||. ||₁ computes L1 norm. The estimated target spectrogram at the reference microphone q is

$${\hat{S}}_{q}^{\left(1\right)} = {\hat{R}}_{q}^{\left(1\right)} + j {\hat{I}}_{q}^{\left(1\right)} ,$$

where j denotes the imaginary unit.

The DNN₂ 236 also has an architecture that is similar to DNN₁ 232, but the DNN₂ 236 may include multiple encoder inputs. Just like for DNN₁ 232, if for DNN₂ 236 having the same architecture as shown is FIG. 4, the predicted RI components are

$${\hat{R}}_{q}^{\left(2\right)}$$

and

$${\hat{I}}_{q}^{\left(2\right)} ,$$

then

$${\hat{S}}_{q}^{\left(2\right)} = {\hat{R}}_{q}^{\left(2\right)} + j {\hat{I}}_{q}^{\left(2\right)}$$

the re-synthesized signal may be computed as

$${\hat{s}}_{q}^{\left(2\right)} = \text{iSTFT} \left({\hat{S}}_{q}^{\left(2\right)}\right) ,$$

where iSTFT(·) uses a shorter output window for overlap-add at the combining 118 step of the audio signal enhancement processing pipeline shown in FIG. 2C, to reduce the algorithmic latency. The loss function for the DNN₂ 236 is then defined on the re-synthesized time-domain signal and its STFT magnitude as:

$$\begin{matrix}{L}_{W a v + M a g} = {\left‖{\hat{s}}_{q}^{\left(2\right)} - {s}_{q}\right‖}_{1} \\ + {\left‖\left|S T F {T}_{L \left({\hat{s}}_{q}^{\left(2\right)}\right)}\right| - \left|S T F {T}_{L \left({s}_{q}\right)}\right|\right‖}_{1}\end{matrix} \qquad \text{(14)}$$

where STFT_{L(.)} extracts a complex spectrogram. Note that STFT_{L(.)} here can use any window types and window and hop sizes and can be different from the ones used to extract Y and Sq, since it is only used for loss computation. For example, the square-root Hann window with a 32 ms window size and an 8 ms hop size may be used to compute this magnitude loss.

In some example embodiments, the mixture of acoustic signals 102 may correspond to a multi-channel signal that may be received from an array of microphones in an audio processing system.

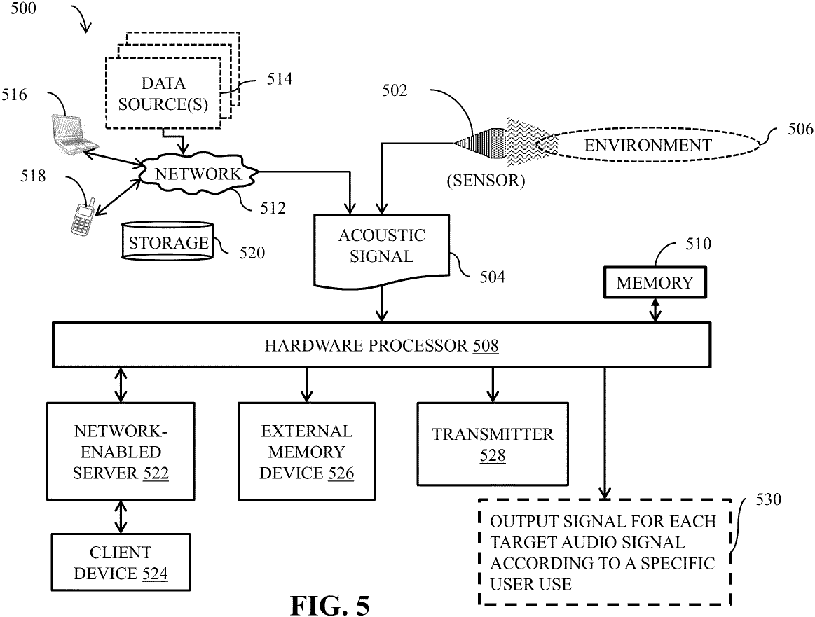

FIG. 5 is a block diagram of an audio signal processing system 500, according to embodiments of the present disclosure. The audio signal processing system 500 uses the signal enhancement system 104. In some example embodiments, the signal enhancement system 104 with the DNNs for enhancement of speech signals, e.g., the DNN₁ 232 and the DNN₂ 236 may be implemented on a remote server or in a cloud network. In some embodiments, the audio signal processing system 500 (referred to hereinafter as system 500) uses a dual window size based processing of an audio signal, using the first window function 200 at an input side and the second window function 214 at an output side.

In some example embodiments, the system 500 includes a sensor 502 or sensors, such as an acoustic sensor, which collects data including an acoustic signal(s) 504 from an environment 506.

The acoustic signal 504 may include a multi-channel audio signal, such as the input mixture of audio signals 102.

The audio signal processing system 500 includes a hardware processor 508 is in communication with a computer storage memory, such as a memory 510. The memory 510 includes stored data, including algorithms, instructions and other data that may be implemented by the hardware processor 508. It is contemplated the hardware processor 508 may include two or more hardware processors depending upon the requirements of the specific application. The two or more hardware processors may be either internal or external. The audio signal processing 500 may be incorporated with other components including output interfaces and transceivers, among other devices.

In some alternative embodiments, the hardware processor 508 may be connected to a network 512, which is in communication with one or more data source(s) 514, computer device 516, a mobile phone device 518 and a storage device 520. The network 512 may include, by non-limiting example, one or more local area networks (LANs) and/or wide area networks (WANs). The network 512 may also include enterprise-wide computer networks, intranets, and the Internet. The audio signal processing system 500 may include one or more number of client devices, storage components, and data sources. Each of the one or more number of client devices, storage components, and data sources may comprise a single device or multiple devices cooperating in a distributed environment of the network 512.

In some other alternative embodiments, the hardware processor 508 may be connected to a network-enabled server 522 connected to a client device 524. The hardware processor 508 may be connected to an external memory device 526, and a transmitter 528. Further, an output for each target speaker may be outputted according to a specific user intended use 530. For example, the specific user intended use 530 may correspond to displaying speech in text (such as speech commands) on one or more display devices, such as a monitor or screen, or inputting the text for each target speaker into a computer related device for further analysis, or the like.

The data source(s) 514 may comprise data resources for training DNNs, such as the DNN₁ 232 and the DNN₂ 236 for a speech enhancement task. For example, in an embodiment, the training data may include acoustic signals of multiple speakers, talking simultaneously. The training data may also include acoustic signals of single speakers talking alone, acoustic signals of single or multiple speakers talking in a noisy environment, and acoustic signals of noisy environment.

The data source(s) 514 may also comprise data resources for training the DNN₁ 232 and the DNN₂ 236 for a speech recognition task. The data provided by data source(s) 514 may include labeled and un-labeled data, such as transcribed and un-transcribed data. For example, in an embodiment, the data includes one or more sounds and may also include corresponding transcription information or labels that may be used for initializing a speech recognition task.

Further, un-labeled data in the data source(s) 514 may be provided by one or more feedback loops. For example, usage data from spoken search queries performed on search engines can be provided as un-transcribed data. Other examples of data sources may include by way of example, and not limitation, various spoken-language audio or image sources including streaming sounds or video, web queries, mobile device camera or audio information, web cam feeds, smart-glasses and smart-watch feeds, customer care systems, security camera feeds, web documents, catalogs, user feeds, SMS logs, instant messaging logs, spoken-word transcripts, gaming system user interactions such as voice commands or captured images (e.g., depth camera images), tweets, chat or video-call records, or social-networking media. Specific data source(s) 514 used may be determined based on the application including whether the data is a certain class of data (e.g., data only related to specific types of sounds, including machine systems, entertainment systems, for example) or general (non-class-specific) in nature.

The audio signal processing system 500 may also include third party devices, which may comprise of any type of computing device, such as an automatic speech recognition (ASR) system on the computing device. For example, the third-party devices may include a computer device, or a mobile device 518. The mobile device 518 may include a personal data assistant (PDA), a smartphone, smart watch, smart glasses (or other wearable smart device), augmented reality headset, virtual reality headset, a laptop, a tablet, a remote control, an entertainment system, a vehicle computer system, an embedded system controller, an appliance, a home computer system, a security system, a consumer electronic device, or other similar electronics device. The mobile device 518 may also include a microphone or line-in for receiving audio information, a camera for receiving video or image information, or a communication component (e.g., Wi-Fi functionality) for receiving such information from another source, such as the Internet or a data source 514. In one example embodiment, the mobile device 518 may be capable of receiving input data such as audio and image information. For instance, the input data may include a query of a speaker into a microphone of the mobile device 518 while multiple speakers in a room are talking. The input data may be processed by the ASR in the mobile device 518 using the system 500 to determine a content of the query. The system 500 may enhance the input data by reducing noise in environment of the speaker, separating the speaker from other speakers, or enhancing audio signals of the query and enable the ASR to output an accurate response to the query.

In some example embodiments, the storage 520 may store information including data, computer instructions (e.g., software program instructions, routines, or services), and/or data related to the DNNs, such as the DNN; 232 and DNN₂ 236 of the system 500. For example, the storage 520 may store data from one or more data source(s) 514, one or more deep neural network models, information for generating and training deep neural network models, and the computer-usable information outputted by one or more deep neural network models.

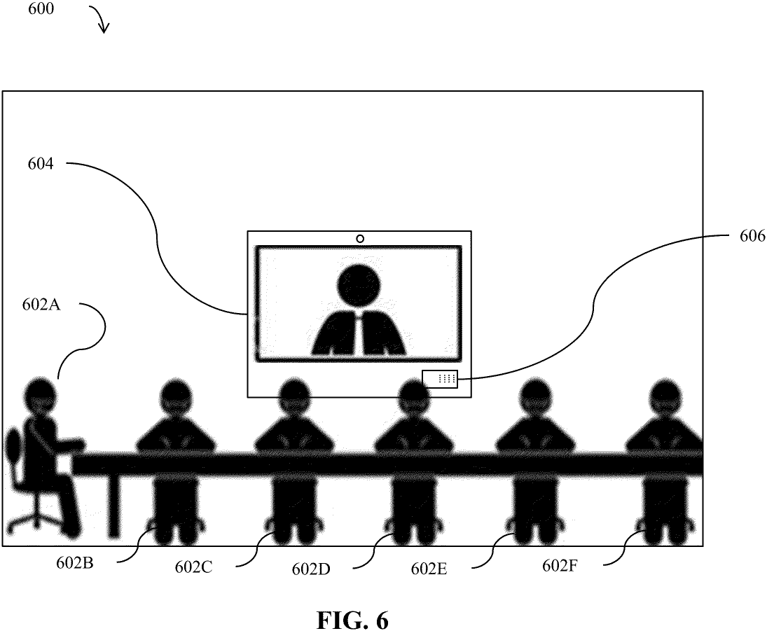

FIG. 6 illustrates a use case 600 for enhancement of audio signals, according to some example embodiments of the present disclosure. The use case 600 corresponds to a teleconferencing room that includes a group of speakers, such as a speaker 602A, a speaker 602B, a speaker 602C, a speaker 602D, a speaker 602E and a speaker 602F (group of speakers 602A-602F). The speech signals of one or more speakers of the group of speakers 602A-602F is received by an audio receiver 606 of a device 604. The audio receiver 606 is equipped with the signal enhancement system 104 and receives acoustic speech signals of a speaker or one or more speakers from the group of speakers 602A-602F, which need to be processed with low latency.

The audio receiver 606 may include a single microphone and/or an array of microphones for receiving a mixture of acoustic signals from the group of speakers 602A-602F as well as noise signals in the teleconferencing room. These mixture of acoustic signals from the group of speakers 602A-602F may be processed by using the system 104. For instance, the system 104 may analyze an RIR model of the teleconferencing room. The RIR model may be used to generate a room geometry construction of the teleconferencing room. The room geometry construction may be used for localization of reflective boundaries in the teleconferencing room. For instance, the corresponding room geometry construction may be used to determine location for installing speakers, seating arrangement of the group of speakers 602A-602F and/or the like to counterbalance noise and other disturbances in the teleconferencing room. Further, the RIR model may be used to remove reflections and reverberation of the speech signals of the one or more speakers of the group of speakers 602A-602F to perform speech signal enhancement.

In an illustrative example scenario, multiple speakers in the group of speakers 602A-602F may output speech signals at same time. In such scenario, the system 104 reduces reverberation in the teleconferencing room and separate speech signals of each of the speakers 602A-602F. The system 104 may also perform a beamforming of the mixture of acoustic signals from array of microphones to enhance speech signals of corresponding speaker in the group of speakers 602A-602F. The enhanced speech signals may be used for transcription of utterances of the speaker. For instance, the device 604 may include an ASR module. The ASR module may receive enhanced speech signals to output the transcription. The transcription may be displayed via a display screen of the device 604.

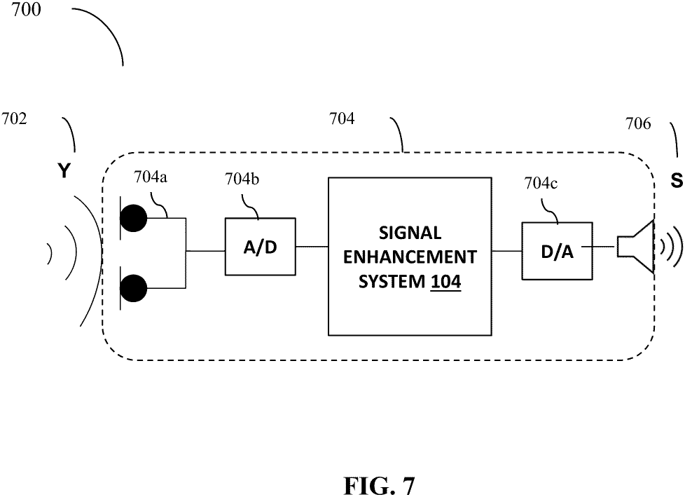

FIG. 7 illustrates a use case 700 for audio signal enhancement is a hearing aid device 704, according to an embodiment of the present disclosure.

The hearing aid device 704 may be configured to receive an input audio signal 702, such as a multi-channel audio input equivalent to input 102 described previously by use of one or an array of microphones 704a. The input audio signal 702 is then passed to an analog-to-digital converter 704b for conversion from analog domain to a digital domain. The digital domain signal is then passed to a signal enhancement system, such as the signal enhancement system 104, for low latency signal enhancement. The signal enhancement system 104 then uses dual window size based processing of the digital domain signal, using DNN based signal enhancement. This DNN based signal enhancement may be used to perform enhancements such as low latency beamforming, noise and reverberation suppression, superior speaker separation and the like, performed by the architectures of DNNs discussed in FIG. 3A, FIG. 3B, FIG. 3C and FIG. 3D, leading to overall improvement in quality of the digital domain signal, but at no extra latency. This high quality audio signal is then amplified and passed to a digital-to-analog converter 704c for outputting enhanced amplified audio signal 706.

Thus, the signal enhancement system 104 may be advantageous to use in numerous low latency audio applications as described above.

The various embodiments described above may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function’s termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The above-described embodiments of the present disclosure may be implemented in any of numerous ways. For example, the embodiments may be implemented using hardware, software, or a combination thereof. When implemented in software, the software code may be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Also, the embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Therefore, it is the object of the appended claims to cover all such variations and modifications as come within the true spirit and scope of the present disclosure.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. A signal enhancement method executed by a computer, the signal enhancement method comprising:
receiving, via an input interface, an input mixture of audio signals including a target audio signal, wherein the input mixture of audio signals is at least one of a multi-channel audio signal or a single-channel audio signal;
partitioning the received input mixture of audio signals into a sequence of input overlapping frames using a first sliding window method, the first sliding window method comprising a first window function having a first width associated with a window of a corresponding frame and a shift length associated with shifting of the window of the first sliding window method;
processing the sequence of the input overlapping frames using a first deep neural network (DNN) to generate enhanced overlapping frames comprising a corresponding enhanced frame for each of the processed frames in the input overlapping frames;
generating a frequency domain filtering output for each frame of the enhanced overlapping frames;
processing, using a second DNN, the frequency domain filtering output for each frame of the enhanced overlapping frames, to generate a corresponding final enhanced frame for each frame of the enhanced overlapping frames; and
combining the final enhanced overlapping frames using a second sliding window method associated with a second window function having a second width less than the first width and the same shift length as the first sliding window method.

2. The signal enhancement method of claim 1, wherein the frequency domain filtering output for each frame of the enhanced overlapping frames is a causal linear filtering output generated by a causal linear filter.

3. The signal enhancement method of claim 1, wherein the frequency domain filtering output for each frame of the enhanced overlapping frames is a beamforming output generated by a beamformer.

4. The signal enhancement method of claim 3, wherein the beamformer is a multi-channel Wiener filter (MCWF).

5. The signal enhancement method of claim 1, wherein the frequency domain filtering output for each frame of the enhanced overlapping frames is a dereverberation output.

6. The signal enhancement method of claim 5, wherein the dereverberation output is obtained based on a convolutive prediction.

7. The signal enhancement method of claim 5, wherein the dereverberation output is obtained based on a weighted prediction error method.

8. The signal enhancement method of claim 1, wherein the second DNN further processes one or a combination of the input overlapping frames and the enhanced overlapping frames.

9. The signal enhancement method of claim 1, wherein one or more of the first window function and the second window function is an asymmetric window function.

10. The signal enhancement method of claim 1, wherein the received input mixture of audio signals is the multi-channel audio signal including speech signals from multiple speakers, and wherein the first DNN produces multiple outputs, each output of the multiple outputs corresponding to a speaker from the multiple speakers.

11. The signal enhancement method of claim 1, wherein the receiving of the input mixture of audio signals comprises
receiving the input mixture of audio signals from an array of microphones connected to the input interface.

12. The signal enhancement method of claim 1, wherein the first DNN is pretrained to generate the enhanced overlapping frames from an observed mixture of acoustic signals.

13. The signal enhancement method of claim 12, wherein the pretraining of the first DNN is performed using a training dataset of mixtures of acoustic signals and corresponding reference target direct-path signals in the training dataset, by minimizing a loss function comprising one or a combination of:
a distance function defined based on real and imaginary (RI) components of a first estimate of an intermediate representation for each frame in a first time-frequency domain and RI components of the corresponding reference target direct-path signal in the first time-frequency domain,
a distance function defined based on a magnitude obtained from the RI components of the first estimate of the intermediate representation for each frame in the first time-frequency domain and corresponding magnitude of the reference target direct-path signal in the first time-frequency domain,
a distance function defined based on a reconstructed waveform obtained from the RI components of the first estimate of the intermediate representation for each frame in the first time-frequency domain by reconstruction in a time domain and a waveform of the reference target direct-path signal,
a distance function defined based on the RI components of the first estimate in a second time-frequency domain obtained by transforming the reconstructed waveform further in the time-frequency domain and the RI components of the reference target direct-path signal in the second time-frequency domain, and
a distance function defined based on the magnitude obtained from the RI components of the first estimate of the intermediate representation for each frame in the second time-frequency domain obtained by transforming the reconstructed waveform further in the time-frequency domain and the corresponding magnitude of the reference target direct-path signal in the second time-frequency domain.

14. A signal enhancement system comprising:
an input interface configured to receive an input mixture of audio signals including a target audio signal, wherein the input mixture of audio signals is at least one of a multi-channel audio signal or a single-channel audio signal;
a memory storing computer-executable instructions;
a processor configured to execute the computer-executable instructions to:
partition the received input mixture of audio signals into a sequence of input overlapping frames using a first sliding window method, the first sliding window method comprising a first window function having a first width associated with a window of a corresponding frame and a shift length associated with shifting of the window of the first sliding window method;
process the partitioned sequence of the input overlapping frames using a first deep neural network (DNN) to generate enhanced overlapping frames, the enhanced overlapping frames comprising a corresponding enhanced frame for each of the processed frame in the overlapping frames ;
generate a frequency domain filtering output for each frame of the enhanced overlapping frames;
process, using a second DNN, the frequency domain filtering output for each frame of the enhanced overlapping frames, to generate a corresponding final enhanced frame for each frame of the enhanced overlapping frames; and
combine the final enhanced overlapping frames using a second sliding window method associated with a second window function having a second width less than the first width and the same shift length as the first sliding window method.

15. The signal enhancement system of claim 14, wherein the frequency domain filtering output for each frame of the enhanced overlapping frames is a causal linear filtering output generated by a causal linear filter.

16. The signal enhancement system of claim 14, wherein the frequency domain filtering output for each frame of the enhanced overlapping frames is a beamforming output generated by a beamformer.

17. The signal enhancement system of claim 16, wherein the beamformer is a multi-channel weiner filter (MCWF).

18. The signal enhancement system of claim 14, wherein the first window function and the second window function are each an asymmetric window function.

19. The signal enhancement system of claim 14, wherein the second DNN further processes one or a combination of the input overlapping frames and the enhanced overlapping frames.

20. The signal enhancement system of claim 14, wherein the received input mixture of audio signals is the multi-channel audio signal including speech signals from multiple speakers, and wherein the first DNN produces multiple outputs, each output of the multiple outputs corresponding to a speaker from the multiple speakers.
